(19) United States
(12) Patent Application Publication
(10) Pub. No.: US 2016/0203286 A1
(43) Pub. Date: Jul. 14, 2016

(54) MEDICAL SUPPORT APPARATUS, METHOD FOR OPERATING MEDICAL SUPPORT APPARATUS, AND MEDICAL SUPPORT SYSTEM

(71) Applicant: FUJIFILM CORPORATION, Tokyo (JP)

(72) Inventors: Yuki OKABE, Tokyo (JP); Yasuyo NENOKI, Tokyo (JP); Yasunori OHTA, Tokyo (JP); Hiroshi HIRAMATSU, Tokyo (JP); Tsuyoshi HIRAKAWA, Tokyo (JP)

(73) Assignee: FUJIFILM CORPORATION, Tokyo (JP)

(21) Appl. No.: 14/994,703

(22) Filed: Jan. 13, 2016

(30) Foreign Application Priority Data
Jan. 14, 2015 (JP) 2015-005436

(51) Int. Cl. G06F 19/00; G06F 3/0481; G06F 3/0482

(52) U.S. Cl. CPC G06F 19/3425; G06F 19/322; G06F 19/321; G06F 19/3406; G06F 3/0482; G06F 3/04817

(57) ABSTRACT

A patient list displayed in a first display screen has an item display section provided along a horizontal axis X (item arrangement axis) and a patient information display section provided along a vertical axis Y (patient identification information arrangement axis). In the item display section, a plurality of items (medical care processes) performed on a patient by medical staffs are arranged. In the patient information display section, pieces of information of a plurality of patients are arranged. Icons are disposed at intersection points of the items in the item display section and the pieces of the patient information in the patient information display section. The icons include a special icon, which contains small icons. The small icons represent progress statuses of medical examinations, respectively.

### CROSS-REFERENCE TO RELATED APPLICATIONS

The present application claims priority under 35 U.S.C. §119 to Japanese Patent Application No. 2015-005436, filed Jan. 14, 2015. Each of the above application(s) is hereby expressly incorporated by reference, in its entirety, into the present application.

### BACKGROUND OF THE INVENTION

1. Field of the Invention

The present invention relates to a medical support apparatus, a method for operating a medical support apparatus, and a medical support system.

2. Description Related to the Prior Art

In medical fields, an efficient operation of team medicine is needed. The team medicine is to treat one patient with two or more medical staffs (e.g. a doctor who diagnoses and treats the patient, a technologist who performs medical examination, a nurse, a dietician, and the like) working in conjunction with each other. To support the efficient operation of the team medicine, a medical support apparatus (“management server” described in Japanese Patent Laid-Open Application Publication No. 2006-338521) generates a display screen that has a patient list, in which progress statuses of medical care processes (e.g. medical care and medical examinations performed on a patient by the medical staffs) are displayed on a patient-by-patient basis. The medical support apparatus outputs the generated display screen to a client terminal, which is operated by the medical staff. The display of the client terminal displays the display screen, which is viewed by each medical staff.

Japanese Patent Laid-Open Application Publication No. 2006-338521 describes medical examinations (e.g. vision test, mydriasis, fundus imaging, and noncontact intraocular pressure measurement) of ophthalmology by way of example. The items of the respective medical examinations are provided in the patient list. Each of the medical examinations and the medical care process items (e.g. name, gender, age and the like of the patient, consultation, treatment, accounting, and the like) other than the medical examinations is arranged side by side in the patient list. A part of the above-described items is displayed in the display screen. The items that cannot be displayed on the display screen can be viewed by operating a horizontal scrollbar.

In the Japanese Patent Laid-Open Application Publication No. 2006-338521, an icon (referred to as “status mark” in the Japanese Patent Laid-Open Application Publication No. 2006-338521) represents the progress status of a medical care process. The icons display multiple types of progress statuses such as “reservation”, “reception”, “examination”, “suspended”, “not checked”, and “checked”. The icons are distinguished from one another by different shapes (circle, triangle, rectangle, and the like) filled with color in different levels, changes in shape and color of the icons, and graphics for easy visual comprehension. The progress statuses of the medical care processes are thus displayed to help the medical staff to comprehend the progress status of the medical care process of the patient, the upcoming medical care process, and the preparation for the upcoming medical care process.

There are many different types of medical care processes performed on the patient by the medical staff as described in the Japanese Patent Laid-Open Application Publication No. 2006-338521. Particularly, in the case of an event such as hospital admission or surgery, the types of medical care processes increase drastically. It is important for the medical staff to grasp the progress statuses of the medical care processes as a whole, and the comprehension influences further efficiency of the team medicine. Since the medical staffs are extremely busy, there is a need to comprehend as many progress statuses of medical care processes as possible at a time with least effort and time.

However, the Japanese Patent Laid-Open Application Publication No. 2006-338521 requires the operation of the horizontal scrollbar to view and grasp the progress statuses of the medical care processes as a whole. Thus, the Japanese Patent Laid-Open Application Publication No. 2006-338521 failed to meet the above-described need of the medical staff.

### SUMMARY OF THE INVENTION

An object of the present invention is to provide a medical support apparatus, a method for operating a medical support apparatus, and a medical support system that enable comprehension of as many progress statuses of medical care processes as possible at a time with least effort and time.

In order to achieve the above and other objects, an aspect of the present invention provides a medical support apparatus comprising a screen generator and a screen display controller. The screen generator is configured to generate a display screen. The display screen has a patient list in which icons are arranged in a matrix in a two-dimensional area with an item arrangement axis and a patient identification information arrangement axis. A plurality of medical care processes performed on patients by medical staffs are arranged as items along the item arrangement axis. Patient identification information for identifying the patients are arranged along the patient identification information arrangement axis. The icons represent progress statuses of the medical care processes on a patient-by-patient basis. The icons include a special icon. Two or more small icons representing the respective progress statuses of the medical care processes are disposed in the special icon. The screen display controller is configured to change a display state of the icon in accordance with a change in the progress status. The icons include the small icons.

It is preferred that the icon is displayed only for the medical care process scheduled to be performed.

It is preferred that the icons include the special icon and a general icon and the general icon represents the progress status of one medical care process. It is preferred that the special icon and the general icon are of the same size. It is preferred that text information about the medical care process is displayed in the general icon. Note that the text information about the medical care process refers to information described in legible and understandable letters and/or characters, and the description of the medical care process is comprehended by viewing the text information.

It is preferred that the progress status represented by the general icon is at least one of “not started”, “not completed”, and “completed”. The progress status “not started” corresponds to a state in which the medical care process has not been started. The progress status “not completed” corresponds to a state in which the medical care process has been started but has not been completed. The progress status “completed” corresponds to a state in which the medical care process has been completed.

It is preferred that the small icons included in one special icon represent the progress statuses of the medical care processes of the same category. It is preferred that the medical care processes of the same category are medical examinations, for example. It is preferred that the medical examination is at least one of imaging examination, laboratory test, and physiological test.

It is preferred that the progress status represented by the small icon is at least one of “not performed”, “not checked”, and “checked”. The progress status “not performed” corresponds to a state in which the medical examination has not been performed. The progress status “not checked” corresponds to a state in which the medical examination has been performed but the medical staff has not checked a result of the medical examination or a medical report that is a report on the result of the medical examination. The progress status “checked” corresponds to a state in which the result of the examination or the medical report has been checked.

It is preferred that the display screen displays the number of the medical examinations with the progress status “not checked”.

It is preferred that the patient list is operated to display detailed information of the medical care process. It is preferred that the detailed information includes a result of the medical examination and a medical report that is a report on the result of the medical examination.

It is preferred that the patient list corresponding the medical staff is generated. It is preferred that at least one of the item displayed, the patient identification information, and the progress status in the patient list varies according to the patient and the medical care process of whom and of which the medical staff is in charge.

It is preferred that the patient list corresponding to a patient type is generated. It is preferred that at least one of the item displayed, the patient identification information, and the progress status in the patient list varies according to the patient type. It is preferred that the patient types include a surgery scheduled patient scheduled to have surgery, an outpatient visiting a medical facility, and an inpatient admitted to the medical facility.

It is preferred that a change in the progress status is represented by changing at least one of a color of the icon, a line type of the icon, a mark displayed in the icon, and a display position of the small icon in the special icon. It is preferred that the mark is a progress bar.

An aspect of the present invention provides a method for operating a medical support apparatus comprising an image generating step and a screen display control step. In the image generating step, a display screen is generated. The display screen has a patient list in which icons are arranged in a matrix in a two-dimensional area with an item arrangement axis and a patient identification information arrangement axis. A plurality of medical care processes performed on patients by medical staffs are arranged as items along the item arrangement axis. Patient identification information for identifying the patients are arranged along the patient identification information arrangement axis. The icons represent progress statuses of the medical care processes on a patient-by-patient basis. The icons include a special icon. Two or more small icons representing the respective progress statuses of the medical care processes are disposed in the special icon. In the screen display control step, a display state of the icon is changed in accordance with a change in the progress status. The icons include the small icons.

An aspect of the present invention provides a medical support system comprised of a medical support apparatus, a client terminal, and a network that connects the medical support apparatus and the client terminal in a communicable manner. The medical support system comprises a screen generator and a screen display controller. The screen generator is configured to generate a display screen. The display screen has a patient list in which icons are arranged in a matrix in a two-dimensional area with an item arrangement axis and a patient identification information arrangement axis. A plurality of medical care processes performed on patients by medical staffs are arranged as items along the item arrangement axis. Patient identification information for identifying the patients are arranged along the patient identification information arrangement axis. The icons represent progress statuses of the medical care processes on a patient-by-patient basis. The icons include a special icon. Two or more small icons representing the respective progress statuses of the medical care processes are disposed in the special icon. The screen display controller is configured to change a display state of the icon in accordance with a change in the progress status. The icons include the small icons.

According to the aspects of the present invention, the special icon, in which the small icons representing the progress statuses of the medical care processes performed on the patient by the medical staffs are disposed, is displayed in the patient list. Thereby a medical support apparatus, a method for operating a medical support apparatus, and a medical support system that enable the comprehension of as many progress statuses of medical care processes as possible at a time with least effort and time are provided.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory view illustrating a medical support system;

FIG. 2 illustrates descriptions of electronic medical records (EMRs) stored in an EMR DB;

FIG. 3 illustrates contents of examination images stored in an image DB;

FIG. 4 illustrates descriptions of medical reports stored in a report DB;

FIG. 5 is a block diagram illustrating a computer that constitutes a medical support server apparatus or a client terminal;

FIG. 6 is a block diagram illustrating each functional part of a CPU of each of the medical support server apparatus and the client terminal;

FIG. 7 illustrates the content of progress status information;

FIG. 8 is an explanatory view illustrating a procedure of a medical examination and each progress status in the procedure;

FIG. 9 illustrates the content of storage location information;

FIG. 10 illustrates the content of staff information;

FIG. 11 illustrates a first display screen;

FIG. 12 illustrates an upper part of a patient list display section;

FIG. 13 illustrates a patient list display section;

FIG. 14 illustrates the content of an item list organized according to patient types and medical staff types;

FIG. 15 illustrates a patient list in a case where the patient type is “inpatient” and the medical staff type is “dietician”;

FIG. 16 illustrates an example of progress statuses displayed, the progress statuses being represented by small icons;

FIG. 17 illustrates an example of progress status displayed, the progress status being represented by general icons;

FIG. 18 illustrates a second display screen;

FIG. 19 illustrates an examination record display section;

FIG. 20 is a flowchart illustrating processes performed by the corresponding sections of the medical support server apparatus and the client terminal;

FIG. 21 illustrates an example in which a speech balloon mark, which shows the number of the medical examinations with the progress status “not checked”, is displayed in the patient information in the patient information display section;

FIG. 22 illustrates an example in which an icon representing an unnecessary medical care process is displayed distinguishably from an icon representing a medical care process to be performed;

FIG. 23 illustrates an example in which the display position of a small icon is changed in a special icon to show a change in the progress status of the corresponding medical examination;

FIG. 24 illustrates a special icon provided with a progress bar;

FIG. 25 illustrates a general icon provided with a progress bar;

FIG. 26 is an explanatory view illustrating an example in which the progress statuses vary according to the medical staff type; and

FIG. 27 is a block diagram illustrating an example in which the client terminal has a function of a medical support apparatus.

### DESCRIPTION OF THE PREFERRED EMBODIMENTS

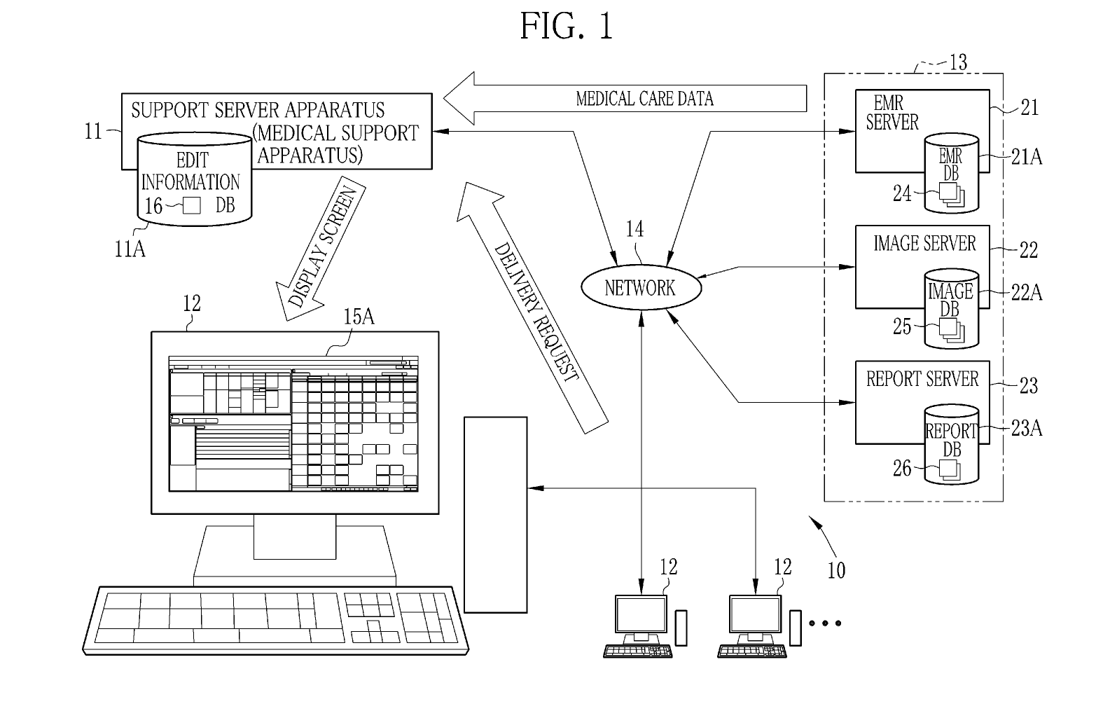

In FIG. 1, a medical support system 10 is a computer system that supports medical care in a medical facility such as a hospital. The medical support system 10 comprises a medical support server apparatus 11, a client terminal apparatus (hereinafter simply referred to as the client terminal) 12, and a server group 13, which are connected to one another in a communicable manner through a network 14 such as a LAN (local area network) provided in the medical facility.

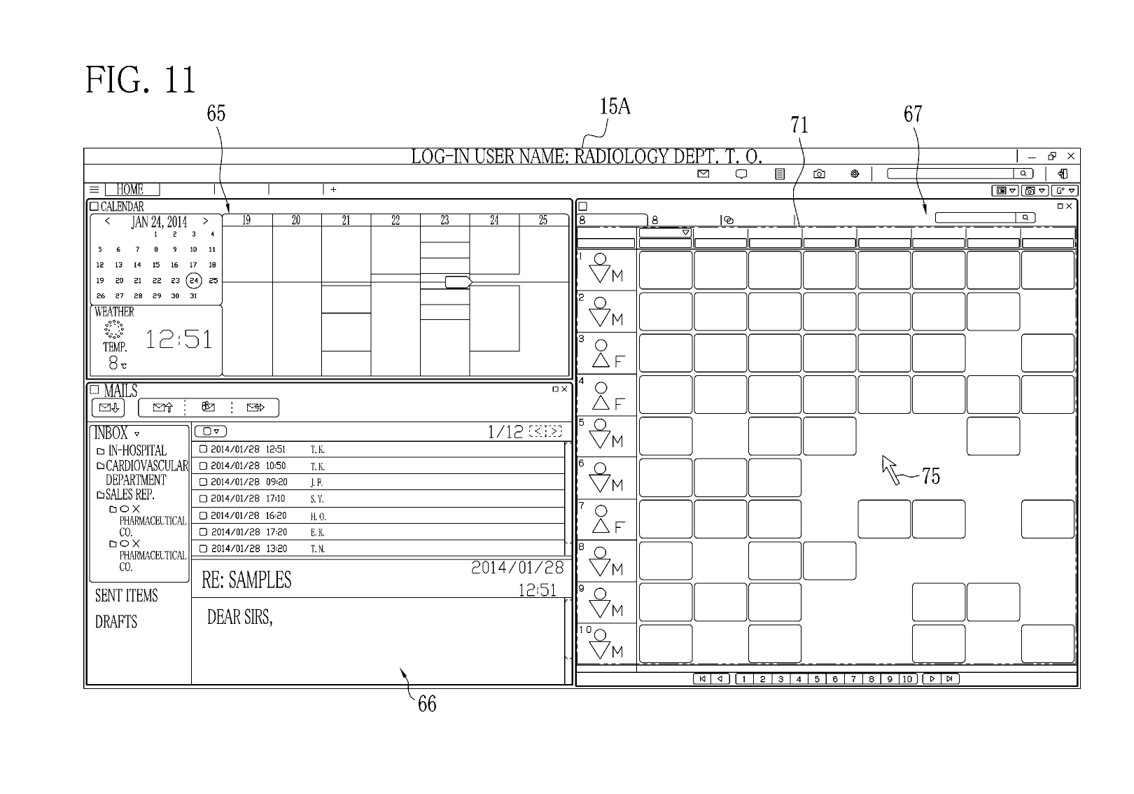

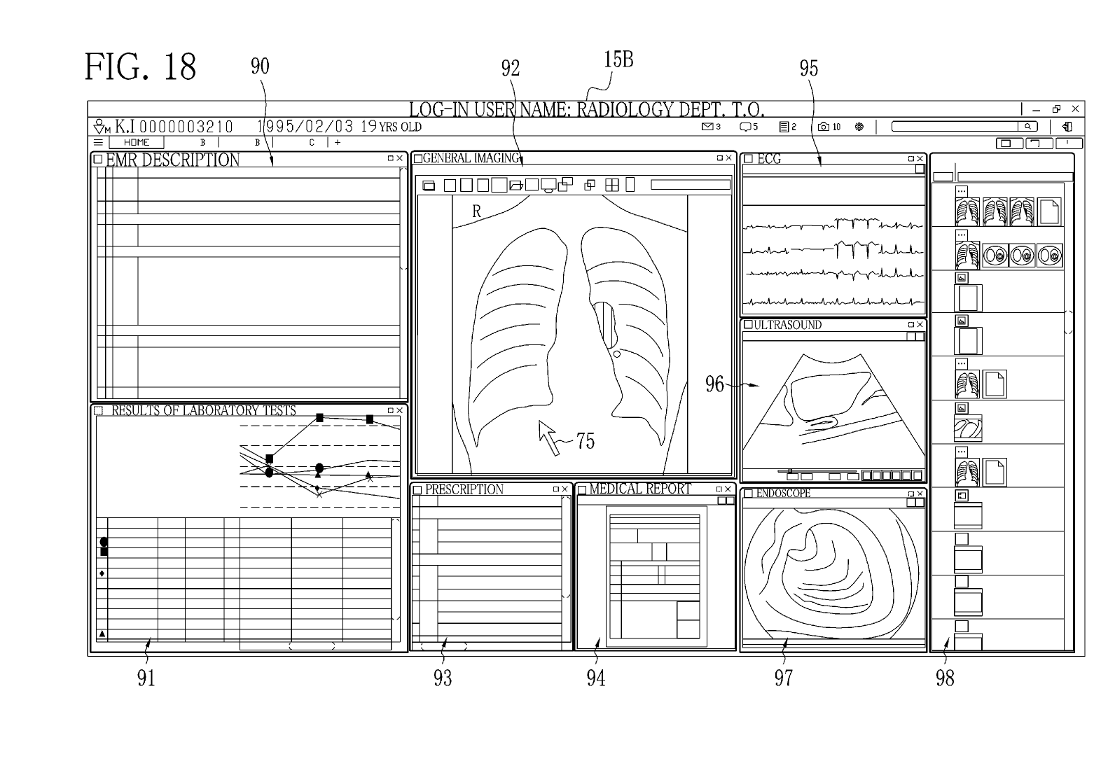

The medical support server apparatus 11 functions as a medical support apparatus according to an aspect of the present invention. To be more specific, the medical support server apparatus 11 retrieves medical care data, which is obtained or prepared during a medical care process of a patient, from the server group 13 and generates a first display screen (or first display page) 15A (which is an example of a display screen, see FIG. 11) and a second display screen (or second display page) 15B (see FIG. 18) based on the medical care data retrieved. The medical support server apparatus 11 delivers the first display screen 15A and the second display screen 15B to the client terminal 12. Note that FIG. 1 illustrates the first display screen 15A.

The medical support server apparatus 11 comprises an edit information database (DB) 11A, in which edit information 16 is stored. The medical support server apparatus 11 refers to the edit information 16 to generate or edit the first display screen 15A and the second display screen 15B.

The client terminal 12 is disposed in each clinical department in the medical facility, for example, internal medicine, surgery, otolaryngology, and ophthalmology, and in each laboratory department, for example, radiological examination department and clinical examination department. The client terminal 12 is operated by the medical staff such as a doctor of a clinical department, a laboratory technologist (hereinafter may simply referred to as the technologist) of a laboratory department, a nurse, or a dietician. The client terminal 12 displays the first display screen 15A and the second display screen 15B, which are transmitted from the medical support server apparatus 11, to be viewed by the medical staff. In other words, the client terminal 12 functions as a viewer terminal, which is used by the medical staff to view the first display screen 15A and the second display screen 15B.

The medical support server apparatus 11 delivers the first display screen 15A and the second display screen 15B in, for example, XML data format for web distribution, which is described by a markup language such as XML (Extensible Markup Language), to the client terminal 12. Based on the XML data, the client terminal 12 reproduces and displays the first display screen 15A and the second display screen 15B on the web browser. Note that another data description language such as JSON (JavaScript (registered trade mark) Object Notation) may be used instead of the XML.

The server group 13 retrieves the medical care data in accordance with a retrieval request, which is a request to retrieve the medical care data, from the medical support server apparatus 11 and transmits the retrieved medical care data to the medical support server apparatus 11. The server group 13 comprises an EMR (electronic medical record) server 21, an image server 22, and a report server 23.

The EMR server 21 comprises an EMR (electronic medical record) database (DB) 21A, in which an electronic medical record (abbreviated as EMR) 24 is stored. Each of the consultation record data, examination data, measurement data, order data, treatment record data, and accounting data is inputted as the medical care data to the EMR 24. In the consultation record data, the descriptions of consultation and diagnosis, the name of the disease, and the like are recorded. The examination data includes test values (test results) of medical examinations (hereinafter may simply referred to as the examinations) such as laboratory test (e.g. blood test, biochemical test, and the like) and physiological test (e.g. electrocardiogram, electroencephalogram, and the like). The measurement data includes measurements of vital signs such as heart rate, pulse rate, blood pressure, body temperature, and the like of a patient. In the order data, various types of orders (requests) for medical examinations, preparation of reports, treatments, surgery (operation), medication, and the like are recorded. In the treatment record data, events throughout the medical care processes of a patient (e.g. first consultation, hospital admission, hospital discharge, hospital readmission, treatments, surgery, medication, and complete remission or cure) are recorded. In the accounting data, consultation and treatment fee, medication fee, hospital admission fee, and the like are recorded. Each of the above-described medical care data of the EMR 24 is inputted and viewed through the client terminal 12.

The image server 22 is a so-called PACS (Picture Archiving and Communication System) server and comprises an image database (DB) 22A, in which an examination image 25 is stored. The examples of examination images 25 include images captured in various types of imaging examinations such as CT (computed tomography) examination, MRI (magnetic resonance imaging) examination, plain radiography examination, ultrasound examination, endoscopy examination, and the like. For example, the examination image 25 is generated in a data file format like DICOM (Digital Imaging and Communications in Medicine) standard. The examination image 25 is viewed through the client terminal 12.

The report server 23 has a report DB 23A, in which a medical report 26 is stored. The medical report 26 describes radiologist's interpretation of the examination image 25, which is captured in the imaging examination. The medical report 26 is prepared and viewed through the client terminal 12.

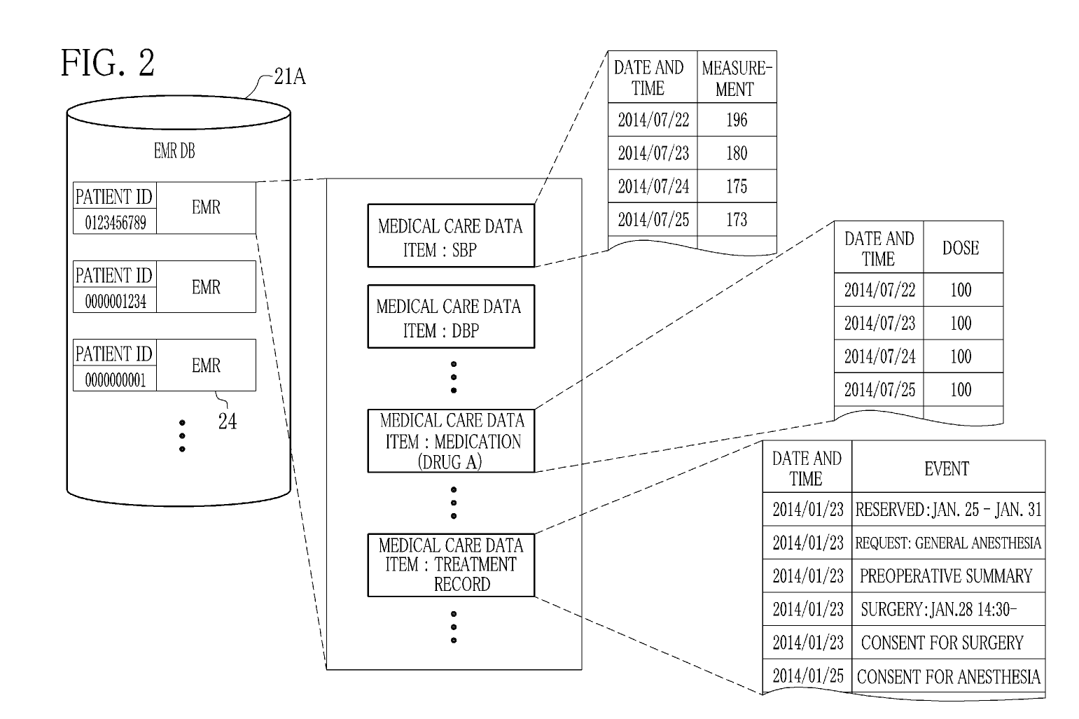

In association with each of the EMR 24, the examination image 25, and the medical report 26, a corresponding patient ID (identification data) and the like are stored as supplementary information (see FIGS. 2 to 4). The patient ID is composed of, for example, numbers and/or characters that identify a patient. A medical staff ID of a medical staff who inputted the medical care data is stored as the supplementary information in association with the EMR 24. The medical staff ID of a laboratory technologist who carried out the examination is stored as the supplementary information in association with the examination image 25. The medical staff ID of a radiologist who prepared the medical report 26 is stored as the supplementary information in association with the medical report 26. The medical staff ID shows which medical staff has performed the medical care process. Note that a medical staff ID is composed of, for example, numbers and/or characters that identify a medical staff. The supplementary information such as the patient ID may be used as a search keyword to retrieve the corresponding EMR 24, examination image 25, and medical report 26 from the respective DBs 21A, 22A, and 23A.

In FIG. 2, the EMR 24, which is stored in the EMR DB 21A, is associated with the corresponding patient ID, which is a 10-digit number such as “0123456789”, and managed on a patient-by-patient basis. In addition to the patient ID, the patient information and two or more items of medical care data are recorded in the EMR 24. The patient information includes the name, gender, the date of birth, age, and the like of the patient. The medical care data is arranged on an item by item basis such as “systolic blood pressure (SBP, the top number)”, “diastolic blood pressure (DBP, the bottom number)”, “biochemical test A”, and “treatment record” and stored chronologically. Note that the medical care data includes the above-described consultation record data, the measurements of the vital signs (e.g. the heart rate, the pulse rate, the body temperature, and the like, in addition to the blood pressure), the order data, and the accounting data (not shown in FIG. 2).

A record of the items of the medical care data of one case include information about dates and times of various events during the medical care process of the patient (e.g. dates and times of consultations, examinations, measurements, and medications (dates of medications or prescriptions)) and data descriptions (e.g. descriptions of diagnostic interview and diagnosis, the results (figures) of examinations and measurements, dose, medical fee, and descriptions of events) (only the dates are illustrated in the drawings but the dates and times are displayed in the actual screen, the same hereinafter). In the case of the item “medication”, there may be a time lag between the administration of a drug and the onset of its clinical effect. For example, in a case where the medication in duration of a certain period (e.g. a predetermined dose per day for 5 days) is prescribed at a time, the dates and times on which the drug is to be taken are recorded as the “dates and times for medication”.

The events recorded in the treatment record data include hospital admission, surgery, referral to another medical department, hospital discharge, hospital readmission, and the like. In the treatment record data, the description of the hospital admission reservation associated with the event “hospital admission”, the description of the request for anesthesia associated with the event “surgery”, the preoperative summary, the description of the application for the surgery, consent for anesthesia, consent for surgery and the like are also recorded. Note that the preoperative summary is a summary of the results of the medical examinations performed before the surgery. The consent for anesthesia and the consent for surgery are the forms that describe the necessity, the risks, and the like of the anesthesia and the surgery, and each form requires the signature (or seal) of the patient or his/her family.

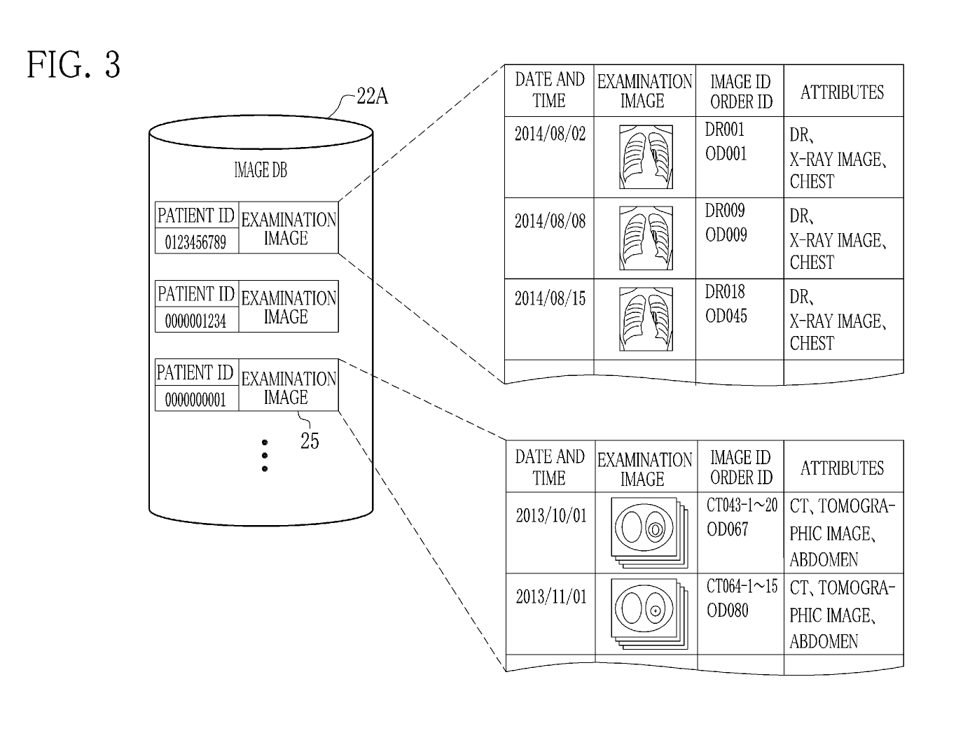

In FIG. 3, the examination image 25 stored in the image DB 22A is associated with the patient ID and managed on a patient-by-patient basis, in a manner similar to the EMR 24. In addition to the patient ID, the examination image 25 is associated with attributes (supplementary information) such as the date and time of the imaging examination (the date and time of uploading the examination image 25 to the image DB 22A), the image ID, the order ID, the type of the imaging examination (e.g. “plain radiography examination”, “CT examination”, or the like), the type of the examination image (“X-ray image”, “tomographic image”, or the like), and the body part captured (e.g. “chest”, “abdomen”, or the like). The image server 22 transmits the examination image 25 as the medical care data along with the supplementary information (the date and time and the attributes of the imaging examination) to the medical support server apparatus 11.

The image ID is composed of numbers and/or characters that identify an examination image 25. The order ID is composed of numbers and/or characters that identify an order. In plain radiography, it is common that one X-ray image is captured per imaging examination. In CT examination, there are cases where two or more tomographic images are captured per imaging examination. In the case where two or more examination images 25 are captured in one imaging examination, one order ID is provided to the examination images 25 captured at a time so that the examination images 25 are managed as a group. This applies the same to the plain radiography in the case where two or more X-ray images are captured in one imaging examination.

Note that the supplementary information of the examination image 25 may include the information about the position and the size of a lesion in the examination image 25, the type of the lesion, a feature quantity of the lesion, the level of healing of the lesion, and the like. In a case where the ultrasound examination is performed as the imaging examination, the supplementary information may include a blood flow measurement, which is obtained by analyzing an ultrasonic image.

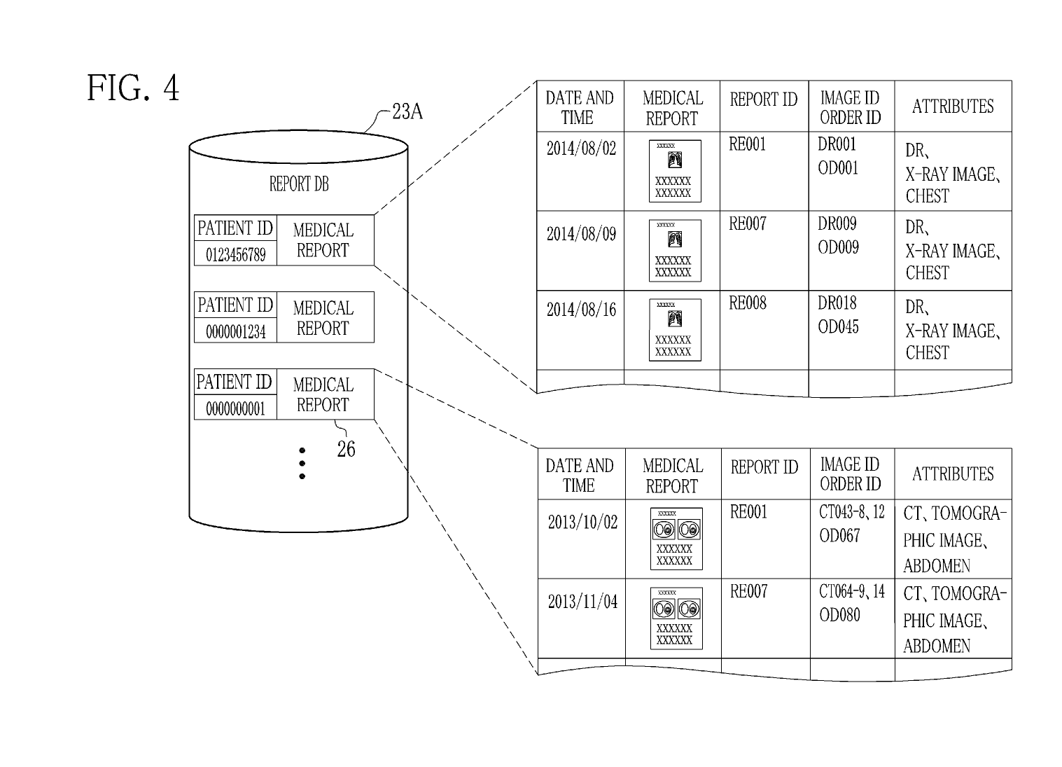

In FIG. 4, the medical report 26, which is stored in the report DB 23A, is associated with the patient ID and managed on a patient-by-patient basis, in a manner similar to the EMR 24 and the examination image 25. The medical report 26 is associated with supplementary information that includes the patient ID, the date on which the medical report 26 is prepared (or the date on which the medical report 26 is uploaded to the report DB 23A), the report ID of the medical report 26, the image ID and the order ID of the examination image 25 attached to the medical report 26, and the attributes similar to those of the examination image 25. The report server 23 transmits the medical report 26 as the medical care data along with the supplementary information to the medical support server apparatus 11. Note that, in FIGS. 2 to 4, only the dates of the dates and times are displayed in the drawings but the dates and times are fully displayed in the actual screen.

Each of the medical support server apparatus 11, the client terminal 12, and the servers 21 to 23 of the server group 13 is comprised of a computer (e.g. a server computer, a personal computer, a workstation, or the like) installed with a control program (e.g. an operating system) and an application program (e.g. a server program or a client program).

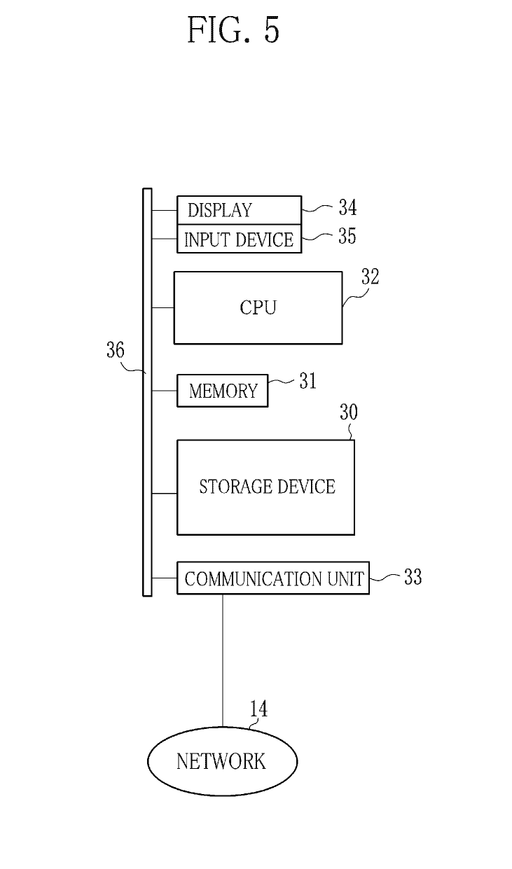

In FIG. 5, the computers that constitute the medical support server apparatus 11, the client terminal 12, and the like have the same or substantially the same basic configuration. Each computer comprises a storage device 30, a memory 31, a CPU (Central Processing Unit) 32, a communication unit 33, a display 34, and an input device 35, which are interconnected through a data bus 36.

The storage device 30 is incorporated in the computer that constitutes the medical support server apparatus 11, the client terminal 12, or the like. The storage device 30 may be a hard disk drive connected to the computer through a cable or a network. The storage device 30 may be a disk array composed of two or more hard disk drives connected. The storage device 30 stores control programs (e.g. operating systems), various types of application programs, and display data of various types of operation screens associated with the programs.

The memory 31 is a working memory, which is used by the CPU 32 to execute processing. The CPU 32 loads the programs, which are stored in the storage device 30, into the memory 31 and executes the processing in accordance with the programs. Thereby the CPU 32 centrally controls each section of the computer.

The communication unit 33 is a network interface that controls transmissions of various types of information through the network 14. The display 34 displays various types of operation screens in accordance with the operation of the input device 35 such as a mouse, a keyboard, or the like. The operation screen is provided with operation functions by a GUI (Graphical User Interface). A computer, which constitutes the medical support server apparatus 11 or the client terminal 12, receives the input of an operation command from the input device 35 through the operation screen. Note that, in the descriptions below, a suffix “A” is attached to a numeral that denotes a part of the computer that constitutes the medical support server apparatus 11 and a suffix “B” is attached to a numeral that denotes a part of the computer that constitutes the client terminal 12.

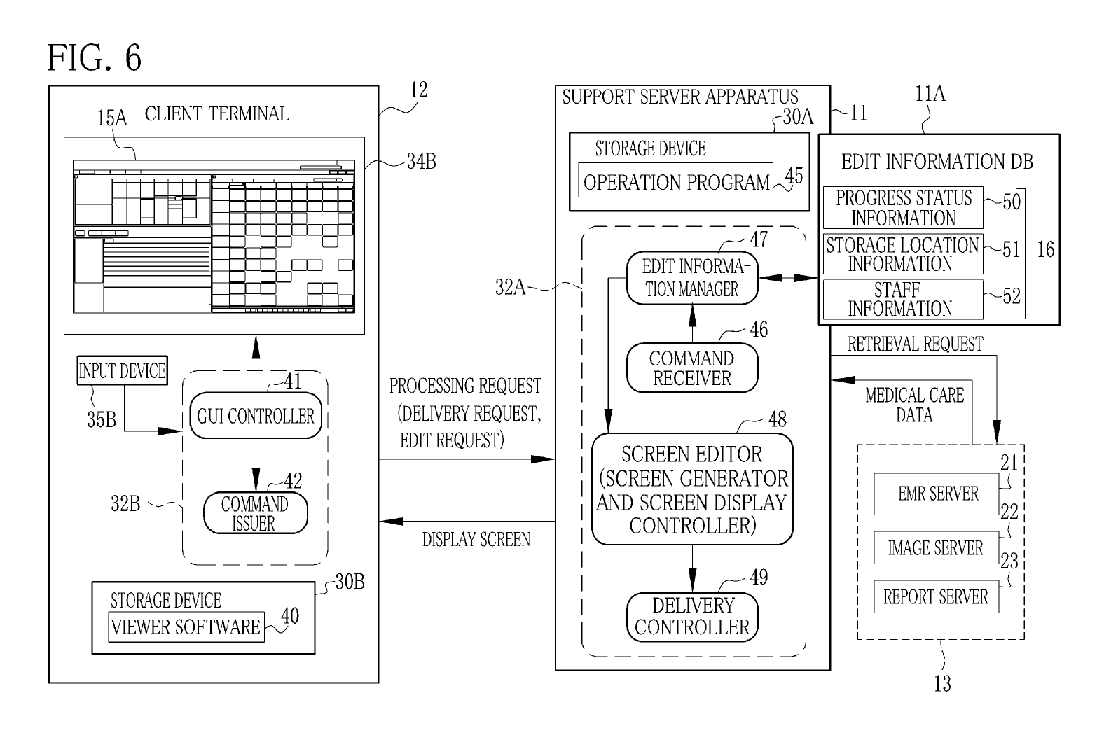

In FIG. 6, a storage device 30B of the client terminal 12 stores viewer software 40 as an application program. The viewer software 40 is used for viewing the first display screen 15A and the second display screen 15B. The viewer software 40 includes two or more gadget engines (hereinafter simply referred to as gadgets) that control the display of multiple display sections that constitute the first display screen 15A and the second display screen 15B. Note that a gadget refers to a subprogram that operates in association with a main application program (e.g. the viewer software 40 or the like) to exert various functions.

Upon the startup of the viewer software 40, a CPU 32B of the client terminal 12 works together with a memory 31B (not shown), thereby functioning as a GUI controller 41 and a command issuer 42.

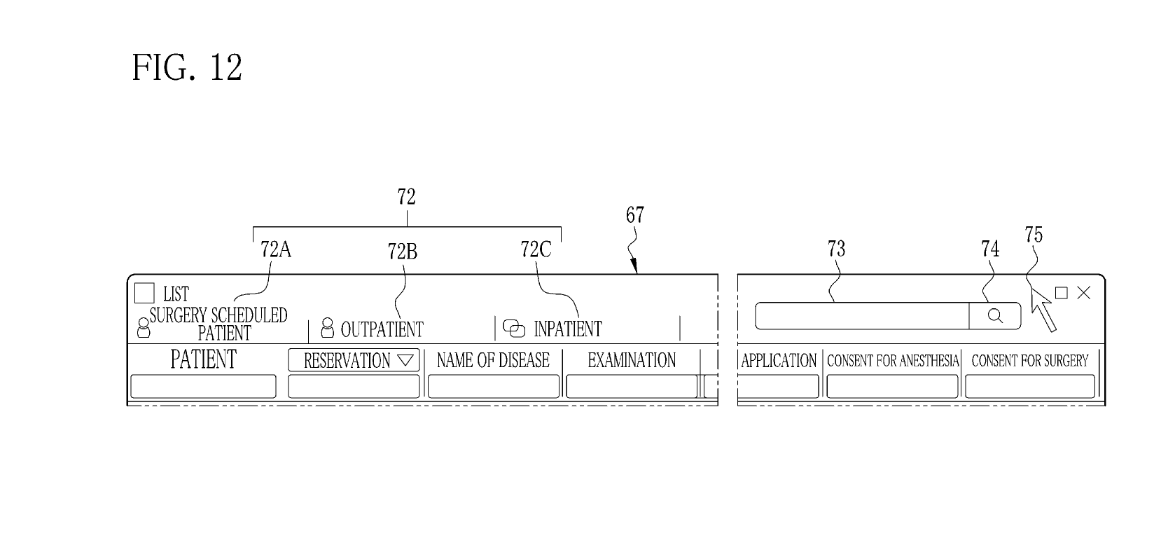

The GUI controller 41 allows the display of the first display screen 15A or the second display screen 15B, which is delivered from the medical support server apparatus 11, on a web browser of the display 34B. The GUI controller 41 controls the output of the screen (the first display screen 15A or the second display screen 15B) in accordance with the operation command inputted from the input device 35B (e.g. clicking a button with a cursor 75 (see FIG. 12 or the like)) through the first display screen 15A or the second display screen 15B.

In accordance with (or in response to) the operation command of the input device 35B inputted through the GUI controller 41, the command issuer 42 issues various types of processing commands (processing requests) to the medical support server apparatus 11. The various types of processing commands include a delivery request for delivering the first display screen 15A and edit requests for editing the first display screen 15A and the second display screen 15B. The various types of processing commands, which are issued by the command issuer 42, are transmitted to the medical support server apparatus 11 through the network 14.

The delivery request includes the medical staff ID. The medical staff ID is inputted together with, for example, an authentication key through a log-in screen (not shown) for starting up the first display screen 15A.

The edit request requests the medical support server apparatus 11 to edit the display content of the first display screen 15A and the second display screen 15B in accordance with various types of operation commands from the input device 35B. The edit request may include a request designating the patient type. With regard to the types (patient types) of the patients treated in the medical facility having the medical support system 10, there are “surgery scheduled patient (patient scheduled for surgery)”, “outpatient”, and “inpatient”. The surgery scheduled patient is a patient who is scheduled to have surgery. The outpatient is a patient who visits the medical facility. The inpatient is a patient who is admitted to the medical facility. Alternatively, for example, the name of the disease may be designated as the patient type.

An operation program 45 is stored as an application program in the storage device 30A of the medical support server apparatus 11. The operation program 45 is a program that allows the computer that constitutes the medical support server apparatus 11 to function as the medical support apparatus. Upon the startup of the operation program 45, the CPU 32A of the medical support server apparatus 11 works together with the memory 31A (not shown), so that the CPU 32A functions as a command receiver 46, an edit information manager 47, a screen editor 48, and a delivery controller 49.

The command receiver 46 receives the delivery request and the edit request from the client terminal 12. The command receiver 46 outputs the received delivery request and the received edit request to the edit information manager 47.

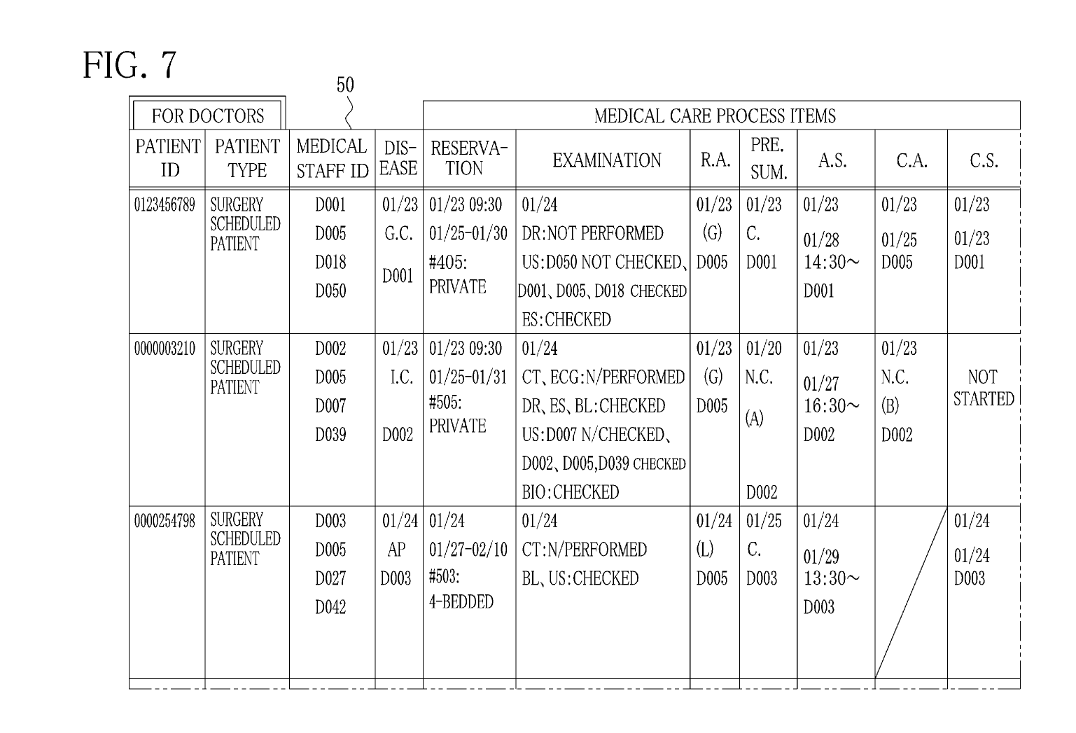

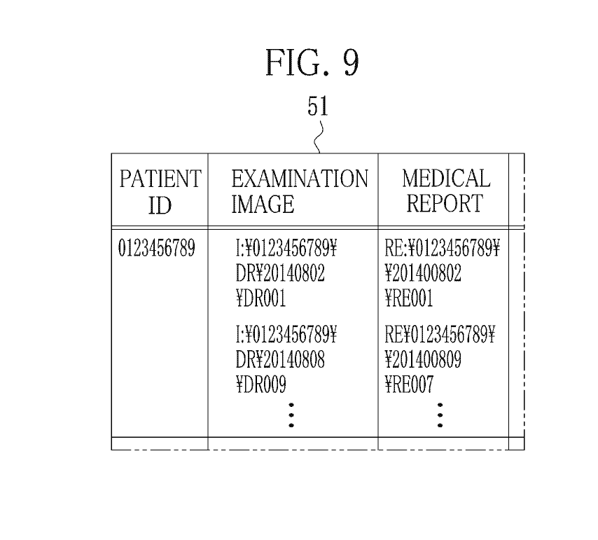

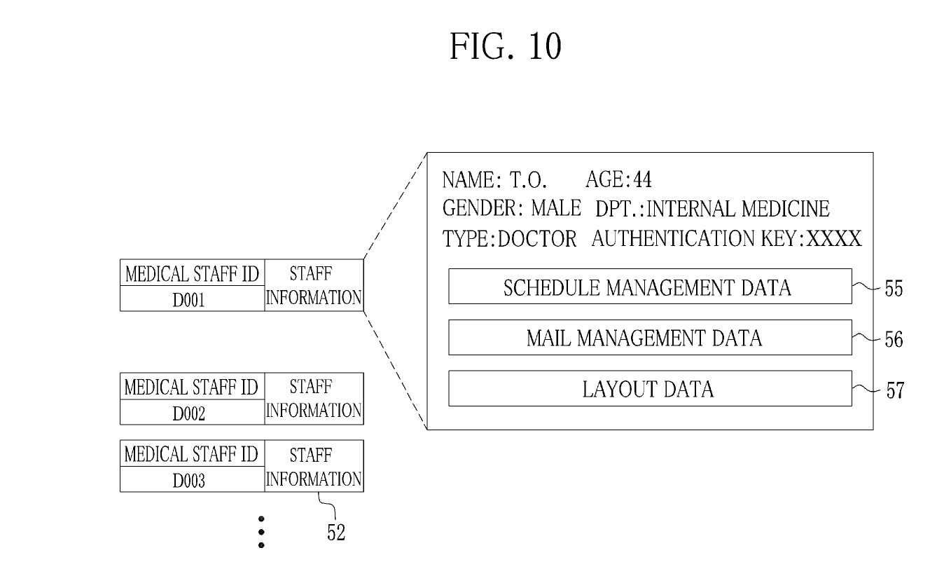

The edit information manager 47 manages the edit information 16 of the edit information DB 11A. The edit information 16 is comprised of progress status information 50 (see FIG. 7), storage location information 51 (see FIG. 9), and staff information 52 (see FIG. 10). The progress statuses of the medical care processes performed on the patients by the medical staffs are stored on a patient-by-patient basis in the progress status information 50. The progress status information 50 is necessary for generating the first display screen 15A. The storage locations of various types of medical care data (e.g. the storage location of the examination image 25 in the image DB 22A, the storage location of the medical report 26 in the report DB 23A, or the like) are stored on a patient-by-patient basis in the storage location information 51. The storage location information 51 is necessary for editing the second display screen 15B. Various types of setting data for the first display screen 15A and the second display screen 15B are stored for each medical staff in the staff information 52.

The edit information manager 47 issues a retrieval request for retrieving the medical care data to the server group 13 at regular time intervals (for example, at intervals of one hour). The edit information manager 47 obtains the medical care data that is transmitted from the server group 13 in response to the retrieval request, and updates the progress status information 50 and the storage location information 51 based on the medical care data obtained. The edit information manager 47 updates the staff information 52 in response to the edit request from the command receiver 46. Note that the time intervals for issuing the retrieval request may be changed depending on the type of the medical care data to be retrieved. For example, the retrieval request for the medical care data about the medical examination may be issued at intervals of one hour. The retrieval request for the medical care data other than the medical examination may be issued at intervals of one day.

In response to the delivery request and the edit request from the command receiver 46, the edit information manager 47 provides the screen editor 48 with the edit information 16 that is necessary for generating or editing the first display screen 15A or editing the second display screen 15B.

The screen editor 48 generates the first display screen 15A based on the edit information 16 provided by the edit information manager 47. Namely, the screen editor 48 functions as a screen generator in this embodiment.

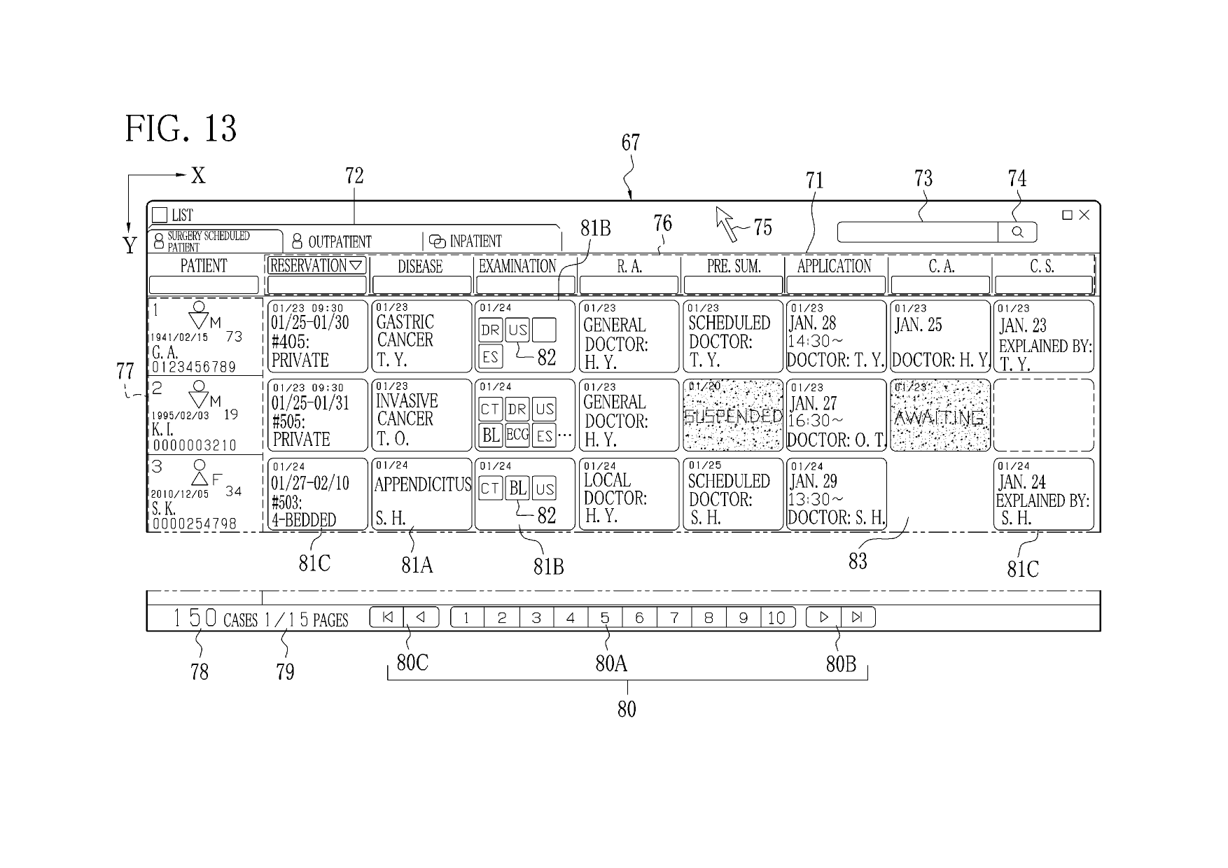

The screen editor 48 functions as a screen display controller, which controls the display of the first display screen 15A and the second display screen 15B. To be more specific, the screen editor 48 edits the display content of the first display screen 15A and the second display screen 15B based on the edit request received by the command receiver 46. The screen editor 48 changes the display state of a general icon 81C or a small icon 82 (see FIG. 13), in accordance with a change in the progress status of the medical care process performed on the patient by the medical staff.

The delivery controller 49 controls the delivery of the first display screen 15A and the second display screen 15B through a communication unit 33A (not shown) to the client terminal 12 that has transmitted the processing request.

In FIG. 7, the progress status information 50 stores the progress statuses of the medical care processes on a patient ID by patient ID basis. The progress status information 50 is comprised of items such as the patient type, the medical staff ID of the medical staff in charge (simply referred to as the medical staff ID), the name of the disease, and the items (or “medical care process items”) corresponding to the medical care processes. Note that, in FIG. 7, the top left tab indicates that the medical staff type is “doctor”, in other words, the progress status information 50 corresponds to the medical staff type “doctor”, by way of example.

One of the “surgery scheduled patient”, the “outpatient”, and the “inpatient” is recorded in the item “patient type”. The “surgery scheduled patient” is a patient whose order data in the EMR 24 has the order for surgery. The “inpatient” is a patient whose treatment record data of the EMR 24 has the event “hospital admission” but does not yet have the event “hospital discharge”. The “inpatient” may be an “surgery scheduled patient” at the same time. In this case, “the surgery scheduled patient” is recorded in the item “patient type”. The “outpatient” is a patient who is neither the “surgery scheduled patient” nor the “inpatient”. The patient type is determined by referring to the medical care data in the EMR 24.

In the item “medical staff ID”, the medical staff ID of a medical staff who is in charge of the treatment of the patient is recorded. The medical staff ID recorded in the item “medical staff ID” is the ID of a medical staff of team medicine working in conjunction with each other to treat the patient. The medical staff is identified by the medical staff ID attached to the medical care data.

In the item “name of the disease”, the name of the disease (e.g. gastric cancer, abbreviated as G.C. in the drawings but fully displayed the actual screen), the date (e.g. “01/23”) on which the name of the disease is recorded, and the medical staff ID (e.g. “D001”) of a doctor (attending physician) who recorded the name of the disease are recorded. The name of the disease and the medical staff ID are determined based on the consultation record data in the EMR 24.

The medical care process items are comprised of items such as “reservation for hospital admission” (abbreviated as “Reservation” in the drawing, the same hereinafter), “examination (medical examination)”, “request for anesthesia” (abbreviated as “R.A.” in the drawing, the same hereinafter), “preoperative summary” (abbreviated as “PRE.SUM.” in the drawing, the same hereinafter), “application for surgery” (abbreviated as “A.S.” in the drawing, the same hereinafter), “consent for anesthesia” (abbreviated as “C.A.” in the drawing, the same hereinafter), “consent for surgery” (abbreviated as “C.S.” in the drawing, the same hereinafter), and the like. Note that the medical care process items and the like are displayed in abbreviations in terms of space in the drawing but they are fully displayed without abbreviations on the actual screen. The information about each medical care process is recorded in the corresponding item. For example, in the item “reservation for hospital admission”, the date and time (e.g. “01/23 09:30”) on which the reservation for hospital admission was made, the period (e.g. “01/25 to 01/30”) of the hospital admission reserved, the hospital room number (e.g. 405), and the type of the room (e.g. private) are recorded. The item “request for anesthesia” displays the date (e.g. “01/23”) on which the request for anesthesia was made, the type of anesthesia (e.g. general anesthesia abbreviated as (G) and local anesthesia abbreviated as (L) in the drawing are fully displayed in the actual screen), and the medical staff ID (e.g. “D005”) of the medical staff who received the request for anesthesia.

In the item “examination”, the date (e.g. “01/24”) of the start of the medical examination and the progress status of each medical examination are recorded. The various types of medical examinations are displayed in abbreviations. For example, CT examination is abbreviated as “CT”, MRI examination is abbreviated as “MR”, plain radiography examination is abbreviated as “DR (Digital Radiography)”, ultrasound examination is abbreviated as “US (Ultrasonography)”, endoscopic examination is abbreviated as “ES (Endoscopy)”, blood test is abbreviated as “BL”, biochemical test is abbreviated as “BIO”, electrocardiogram is abbreviated as “ECG”, electroencephalogram is abbreviated as EEG, and the like.

The progress statuses of the medical care process items (other than the examinations) include “not started”, “not completed”, and “completed”. The progress status “not started” corresponds to a state in which the medical care process has not been started. The progress status “not completed” corresponds to a state in which the medical care process has been started but has not been completed. The progress status “completed” corresponds to a state in which the medical care process has been completed. In an example illustrated in FIG. 7, the item “consent for surgery” of the patient ID “0000003210” corresponds to the progress status “not started”. In this case, “not started” is recorded in the corresponding medical care process item. Each of the items “preoperative summary” and “consent for anesthesia” of the patient ID “0000003210” corresponds to the progress status “not completed” (abbreviated as N.C. in the drawing, but fully displayed in the actual screen). In this case, in each medical care process item, the reason why the medical care process has not been completed is described. For example, the preoperative summary has not been completed because it has suspended due to metastasis to liver (denoted as (A) or “suspended” in the drawings but the description and the name of the doctor or the like are fully displayed in the actual screen). For example, the consent for anesthesia has not been completed because the patient's submission of the consent is awaited (denoted as (B) or “awaiting” in the drawings but the description and the name of the doctor or the like are fully displayed in the actual screen). In the medical care process items, the dates (e.g. “01/20” and the like) on which the reasons are inputted and the medical staff IDs (“D002” and the like) of the medical staffs who inputted the reasons are also recorded. The progress status “completed” (abbreviated as “C” in the drawing but it is fully displayed in the actual screen) corresponds to the medical care process items such as the preoperative summary of the patient ID “0123456789” and the reservation for hospital admission of the patient ID “0000254798”, for example. The medical care process item corresponding to the unnecessary medical care process (e.g. “the consent for anesthesia” of the patient ID “0000254798”) is left blank with nothing recorded in it.

The progress statuses of the medical examinations include “not performed” (abbreviated as “N/performed” in the drawing but is fully displayed in the actual screen), “not checked” (abbreviated as “N/checked” in the drawing but is fully displayed in the actual screen), and “checked”. The progress status “not performed” corresponds to a state in which the medical examination has not been performed. The progress status “not checked” corresponds to a state in which the medical examination has been performed and the medical report 26 has been prepared but the medical staff has not checked the medical report 26. The progress status “checked” corresponds to a state in which the medical staff has checked the medical report 26. Whether the progress status of the medical examination is “checked” or “not checked” depends on whether each medical staff has checked the medical report 26. With regard to the medical examinations other than those with the progress status “not performed” or “checked (by all the medical staffs involved in the medical examination)”, the medical staff ID of the medical staff who has not checked the medical report 26 yet is displayed along with the medical staff ID of the medical staff who has checked the medical report 26 already (e.g. “US: D050 with the progress status “not checked” and D001, D005, and D018 with the progress status “checked” are displayed in the item “examination” of the patient ID “0123456789”).

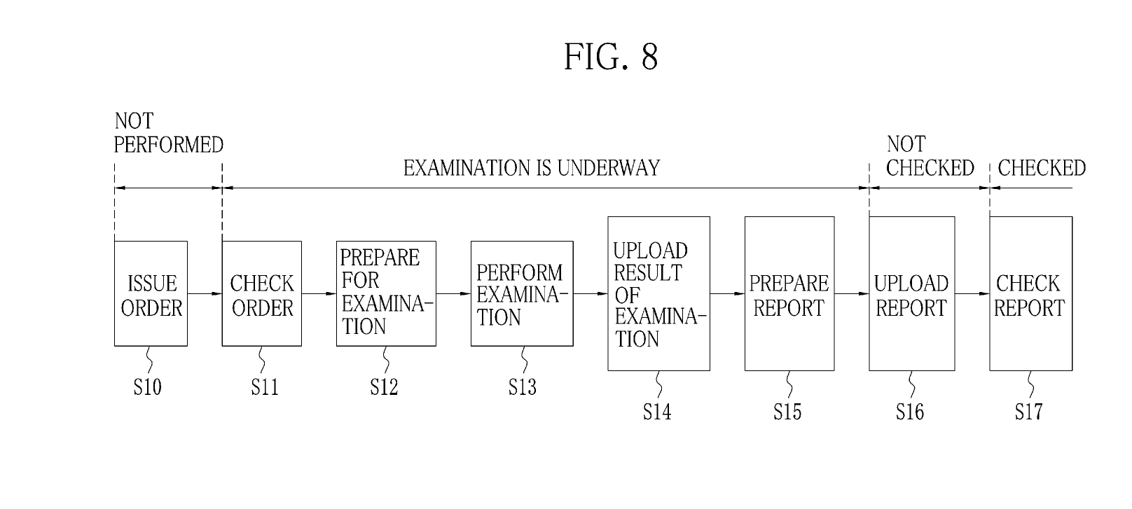

Here, the medical examination is performed in a procedure illustrated in FIG. 8. First, a doctor of a clinical department issues an order for a medical examination on the EMR 24 (S10). The order issued is transmitted to the client terminal 12 of a corresponding examination department and the laboratory technologist makes a check of the order through the client terminal 12 (S11). Based on the order checked, the laboratory technologist makes the examination equipment ready and calls the patient into the examination room to prepare for the medical examination (S12). Then the medical examination is performed based on the order checked (S13).

After the medical examination, the result of the examination is uploaded (S14). In the case where the medical examination is the imaging examination, the examination image 25 is uploaded as the result of the examination to the image DB 22A of the image server 22. In the case where the medical examination is a laboratory test or a physiological test, the test measurements are uploaded as the result of the examination to the EMR DB 21A of the EMR server 21. In the case where the medical examination is the imaging examination and the result of the examination is uploaded, the radiologist in charge of preparing the medical report 26 is informed of the upload.

The radiologist views the uploaded result of the examination through the client terminal 12 and prepares the medical report 26 based on the result of the examination (S15). The medical report 26 is uploaded to the report DB 23A of the report server 23 (S16). In the case where the medical report 26 is uploaded, the doctor who ordered the medical examination is informed of the upload.

The doctor views the uploaded medical report 26 through the client terminal 12 and checks the content of the medical report 26 (S17). Referring to the medical report 26, the doctor makes a diagnosis or works out on a treatment plan. The above describes an outline of the procedure of the medical examination.

The progress status “not performed” corresponds to a period after the order is issued (S10) and before the order is checked (S11). The progress status “not checked” corresponds to a period after the medical report 26 is uploaded (S16) and before the medical report 26 is checked (S17). The progress status “checked” corresponds to a period after the medical report 26 is checked (S17). Note that the medical examination is underway in a period after the order is checked (S11) and before the medical report 26 is uploaded (S16). Thus, the progress status of the medical examination changes from moment to moment. The progress status of the medical care process other than the medical examination also changes from moment to moment.

In the storage location information 51 illustrated in FIG. 9, the storage locations of the medical care data are recorded on a patient ID by patient ID basis. The storage location information 51 is comprised of items such as “examination image” 25 and “medical report” 26. In addition to the items illustrated, the storage location information 51 is provided with the items of other medical care data such as “examination data”, which are the results of the laboratory test and the physiological test, “measurement data” of the vital signs, and the like. In each item, a path (for example, “I:¥0123456789¥DR¥20140808¥DR001” or the like) that indicates the storage location of the corresponding medical care data is recorded.

In FIG. 10, the staff information 52 is associated with the medical staff ID and managed on a medical staff by medical staff basis. In the staff information 52, basic information of the medical staff such as the name (the names are displayed in initials in the drawings but the full spellings are displayed in the actual screen, the same hereinafter), age, and gender of the medical staff, the department to which the medical staff belongs, the type of the medical staff (e.g. doctor, technologist, nurse, or dietician), and the authentication key of the medical staff is recorded. In addition, in the staff information 52, schedule management data 55, mail management data 56, and layout data 57 are recorded as various types of setting data related to the first display screen 15A and the second display screen 15B.

In the schedule management data 55, the schedule (e.g. outpatient consultation, inpatient rounds, attending a medical congress, class lecture, leave, or the like) of a medical staff is recorded in association with the date and time. In the mail management data 56, the emails delivered to a medical staff and the emails written and sent by the medical staff are recorded. In the layout data 57, the layout settings of the first display screen 15A and the second display screen 15B which are customized by the medical staff are recorded.

In FIG. 11, the first display screen 15A comprises three display sections 65 to 67: the schedule display section 65 in the upper left portion, the mail display section 66 in the lower left portion, and the patient list display section 67 in the right portion.

A schedule management gadget generates the schedule display section 65. The schedule management gadget controls the displays of a calendar, the current time, weather and outside-air temperature of an area in which the medical facility is located, and the like in the schedule display section 65. Based on the schedule management data 55, the schedule management gadget also controls the display of weekly schedule of the medical staff whose medical staff ID is inputted through the log-in screen (the schedule such as the reservations for the medical examinations, the outpatient consultations, and the like is not displayed in the boxes in the calendar in the drawing but it is displayed in the actual screen).

The schedule management gadget accepts a writing operation of the schedule through the schedule display section 65. The command issuer 42 issues the edit request that includes the schedule written through the schedule display section 65. The edit information manager 47 records the schedule included in the edit request to the schedule management data 55 and thus updates the schedule management data 55.

The mail display section 66 is generated by the mail management gadget. Based on the mail management data 56, the mail management gadget controls the display of the list of emails (those delivered to the medical staff whose medical staff ID is inputted through the log-in screen) on the mail display section 66 and the display of the content of an email.

The mail management gadget accepts various operations such as checking for new emails, replying the emails, and creating emails through the mail display section 66. The command issuer 42 issues the edit request that includes various operations inputted through the mail display section 66. The edit information manager 47 records the data corresponding to the various operations included in the edit request, on the mail management data 56, and thereby updates the mail management data 56.

The schedule management gadget and the mail management gadget are included in a plurality of gadgets in the viewer software 40. The schedule displayed in the schedule display section 65 and the content of the email displayed in the mail display section 66 are switched in accordance with the medical staff ID inputted through the log-in screen. Note that the positions, areas, and the display contents of the respective display sections 65 to 67 are customized freely by the medical staff. For example, the entire left area may be used as the mail display section 66 and the schedule display section 65 may be omitted. For example, the schedule display section 65 may be disposed on the lower left and the mail display section 66 may be disposed on the upper left. Such layout settings are recorded in the layout data 57 by the edit information manager 47.

A patient list display section 67 displays a patient list 71 (in FIG. 11, the characters and the like are not displayed in the patient list 71 but they are displayed in the actual screen and the patient list 71 is the same as the one enlarged and displayed in FIG. 13). The patient list 71 displays the progress statuses of a plurality of medical care processes of the patients treated by the medical staff whose medical staff ID has been inputted through the log-in screen. The progress statuses are displayed on a patient-by-patient basis. Note that each of the patient list display section 67, the schedule display section 65, and the mail display section 66 can be enlarged and displayed full screen in the first display screen 15A.

The patient list 71 corresponding to the medical staff is generated by the screen editor 48. To be more specific, for example, in a case where the medical staff ID “D001” is inputted through the log-in screen, the edit information manager 47 picks up (retrieves) the progress status information 50 (in the example illustrated in FIG. 7, the progress status information 50 of the patient ID “0123456789”) in which the medical staff ID “D001” is recorded in the item “medical staff ID” and transmits the retrieved progress status information 50 to the screen editor 48. Based on the progress status information 50 transmitted, the screen editor 48 generates the patient list 71 that represents the progress statuses of the medical care processes of the patient(s) treated by the medical staff with the medical staff ID “D001”. Hence the patients displayed in the patient list 71 vary according to the patients who are taken care of by the medical staff.

In FIG. 12, a patient type selection tab 72 for selecting (switching) the patient type, a search input box 73 to which the name of the disease is inputted as the patient type, and a search button 74 are provided in an upper portion of the patient list display section 67. The patient type selection tab 72 is provided with tabs 72A, 72B, and 72C representing “surgery scheduled patient”, “outpatient”, and “inpatient”, respectively. The patient type selection tab 72, the search input box 73, and the search button 74 are provided to narrow down the patients displayed in the patient list 71 by the patient type.

In response to selecting one of the tabs 72A to 72C with the cursor 75 from the patient type selection tab 72 or in response to inputting the name of the disease to the search input box 73 and choosing the search button 74 with the cursor 75, the command issuer 42 issues the corresponding edit request. The edit information manager 47 provides the screen editor 48 with the progress status information 50 that has the patient type designated by the edit request, out of the progress status information 50 picked up (retrieved) based on the delivery request. Based on the progress status information 50 provided by the edit information manager 47, the screen editor 48 edits the patient list 71 that is narrowed down by the patient type.

FIG. 13 illustrates an example of the patient list 71 corresponding to a case in which the medical staff type of the medical staff ID (of the medical staff) inputted through the log-in screen is “doctor” and the tab (surgery scheduled patient) 72A of the patient type selection tab 72 is selected.

In FIG. 13, the patient list 71 comprises an item display section 76 and a patient information display section 77. In an upper portion of the patient list 71, the item display section 76 is provided along a horizontal axis X, which corresponds to an item arrangement axis, by way of example. On a left side portion of the patient list 71, the patient information display section 77 is provided along a vertical axis Y, which corresponds to a patient identification information arrangement axis, by way of example. The vertical axis Y is orthogonal to the horizontal axis X. In the item display section 76, the medical care process items (illustrated in FIG. 7 by way of example) are arranged. The medical care process items include the items such as the name of the disease, the hospital admission reservation, the examination, the request for anesthesia, the preoperative summary, the application for surgery, the consent for anesthesia, and the consent for surgery. The medical care process items are arranged from left to right in an order of a normal procedure of the medical care processes. The item display section 76 has a sort function to sort the patients in the patient list 71 to change the order of the patients displayed in the patient list 71. For example, the patients may be sorted based on the date of the scheduled date of the hospital admission in the hospital admission reservation or the scheduled date of surgery in the application for surgery, in an order of earlier to later. The patients may be sorted based on the progress status of a medical care process, in the order of “not started”, “not completed”, and “completed”. The patients may be sorted based on the number of the medical examinations with the progress status “not performed”, in a descending order.

In the patient information display section 77, the patient information of each patient is displayed along with the number indicating the patient's ordinal position in the list. The patient information refers to (or includes) the name, the patient ID, gender, the date of birth, and age of the patient described in the EMR 24. Of the patient information, the name and the patient ID correspond to patient identification information, by way of example. The gender is represented by a sign signifying male or female and a letter “M (male)” or “F (female)”. For example, the patient information of 10 patients are displayed at a time in the patient information display section 77 (see FIG. 11).

In a bottom portion of the patient list display section 67, the total number of cases (patients) 78 (e.g. “150 cases” illustrated in FIG. 13) that have been retrieved by the edit information manager 47 and displayed in the patient list 71, the number of the page displayed and the total number of the pages (e.g. “page 1/15” meaning that the page 1 is displayed out of total 15 pages) 79 in the patient list 71 displayed in the patient list display section 67, and a page select button group 80. The page select button group 80 is composed of a button 80A, a page forward button 80B, and a page back button 80C. The button 80A, which indicates the page numbers, is disposed between the page forward and back buttons 80B and 80C. In response to selecting one of the buttons 80A to 80C with the cursor 75, the command issuer 42 issues the edit request that includes a command to select the page of the patient list 71. Based on the edit request, the screen editor 48 switches the page of the patient list 71.

Icons 81 are arranged in a matrix in a two-dimensional area comprised of the item display section 76 and the patient information display section 77. More specifically, the icons 81 are arranged at the intersection points of the items in the item display section 76 and the pieces of the patient information in the patient information display section 77, respectively. There are three types of the icons 81: disease icons 81A, special icons 81B, and general icons 81C. The icons 81A to 81C are of the same size.

The disease icon 81A is disposed at the intersection point of the item “name of the disease (simply referred to as the disease)” in the item display section 76 and the patient information in the patient information display section 77. In the disease icon 81A, the name of the disease, the date on which the name of the disease is recorded, and the name of the doctor (attending physician) who recorded the name of the disease are displayed. The name of the disease and the date on which the name of the disease is recorded are recorded in the item “the name of the disease” in the progress status information 50. The name of the doctor is obtained from the staff information 52 of the medical staff ID recorded in the item “the name of the disease” in the progress status information 50. Note that the disease icon 81A may display the name of the clinical department (e.g. neurosurgery or cardiovascular medicine) that provides the medical care.

The special icon 81B is disposed at the intersection point of the item “examination” in the item display section 76 and the patient information in the patient information display section 77. The special icon 81B displays the date (e.g. “01/24” and the like) on which the medical examination has started. The special icon 81B is an icon in which two or more small icons 82 are disposed. For example, six small icons 82 are disposed (displayed) at the maximum in the special icon 81B.

The small icons 82 represent the progress statuses of the various types of medical examinations, for example, the imaging examinations such as the CT examination, the MRI examination, the plain radiography, the ultrasound examination, and the endoscopic examination, the laboratory tests such as the blood test and the biochemical test, and the physiological tests such as the ECG examination and the EEG examination. The small icon 82 displayed corresponds to only the medical examination whose order has been issued on the EMR 24 by a doctor in a clinical department and that has been scheduled. The small icon 82 is not displayed for an unnecessary medical examination, which is not scheduled.

In the small icon 82, letters (or characters) representing the medical examination are displayed. The letters displayed in the small icon 82 are same as the abbreviation of the medical examination described in the item “examination” of the progress status information 50. In other words, the CT examination is abbreviated as “CT”, the MRI examination is abbreviated as “MR”, the plain radiography examination is abbreviated as “DR”, the ultrasound examination is abbreviated as “US”, the endoscopic examination is abbreviated as “ES”, the blood test is abbreviated as “BL”, the biochemical test is abbreviated as “BIO”, the electrocardiogram is abbreviated as “ECG”, and the electroencephalogram is abbreviated as “EEG”. Since the small icon 82 is smaller in size than the icon 81, simple abbreviation (or initials) with few letters (e.g. one letter abbreviation, or two- or three-letter abbreviation) is used in the small icon 82 to distinguish the medical examinations from one another.

The general icon 81C is disposed at the intersection point of the medical care process item other than the item “examination” in the item display section 76 and the patient information in the patient information display section 77. In the general icon 81C, text information about the corresponding medical care process is described. The text information is described in legible and understandable letters or characters and is comprehended by viewing the text information. For example, in the general icon 81C disposed corresponding to the item “hospital admission reservation”, the date and time on which the hospital admission reservation was made, the period reserved for the hospital admission, the hospital room number, and the type of the room are displayed. In the general icon 81C disposed corresponding to the item “the request for anesthesia”, the date on which the request for anesthesia was made, the type of the anesthesia, and the name of the doctor who accepted (received) the request for anesthesia are displayed. In the general icon 81C disposed corresponding to the item “application for surgery”, the date on which the application for the surgery was made, the scheduled date and time of the surgery, and the name of the doctor who is scheduled to perform the surgery are displayed. Such information has been recorded in the medical care process items of the progress status information 50. Note that additional text information about the medical care process may be added to the text information in the general icon 81C (for example, in a case where an operative procedure (or a technique) of the surgery is displayed on the general icon 81C disposed corresponding to the item “application for surgery”).

As in the case of the small icon 82, the general icon 81C is displayed only for the medical care process that is scheduled to be performed and whose order (e.g. surgery or the like) is recorded in the order data of the EMR 24 by a doctor of a clinical department. The general icon 81C is not displayed for an unnecessary medical care process (e.g. “the consent for anesthesia” of the patient ID “0000254798”). Such unnecessary medical care process in the patient list 71 is left as a blank space 83.

The icons 81A to 81C are displayed in predetermined colors, respectively, on an item by item basis. For example, the color of the general icon 81C disposed corresponding to the item “hospital admission reservation” is russet brown. The color of the special icon 81B and the small icon 82 disposed corresponding to the item “examination” is yellow ocher (ochre). The color of the general icon 81C disposed corresponding to the item “request for anesthesia” is greenish brown. The color of the general icon 81C disposed corresponding to the item “application for surgery” is dark green. The color of the general icon 81C disposed corresponding to the item “the consent for surgery” is indigo blue. The icons 81A to 81C are displayed in chromatic colors. Normally, the letters and characters in each of the icons 81A to 81C and the small icons 82 and the frames (frame lines) of the small icons 82 are displayed in white (in other words, white characters and white frame lines are on a colored background), for example.

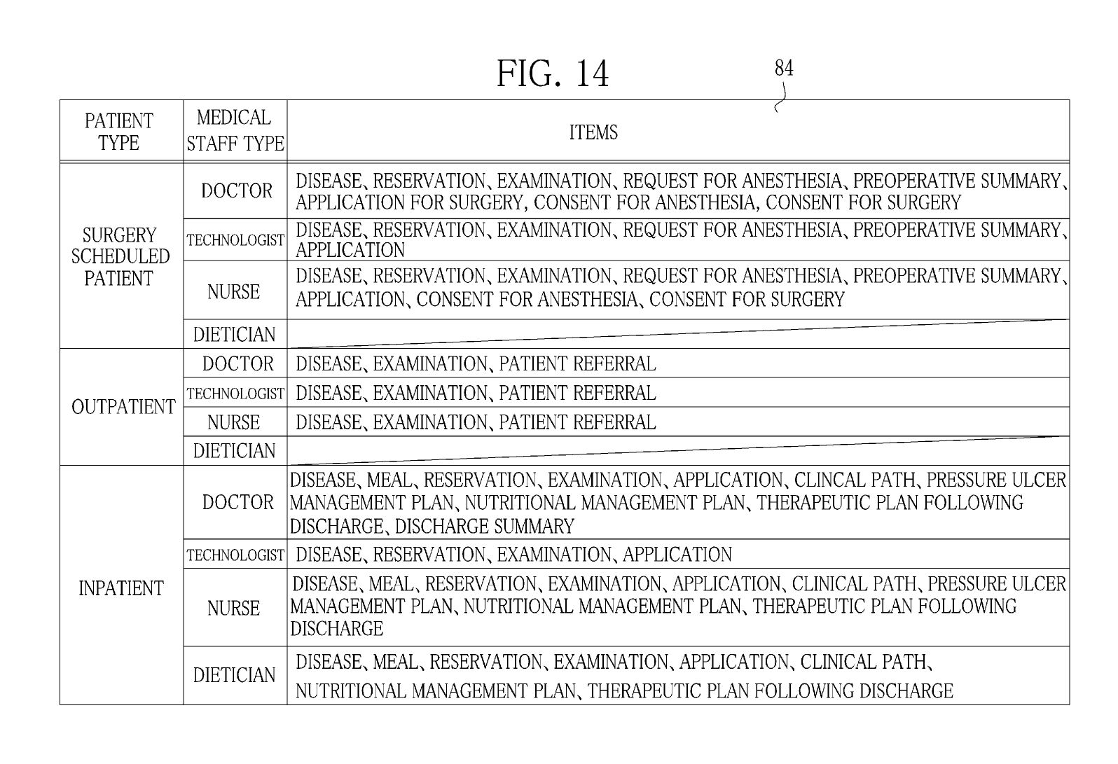

The medical care process performed on the patient by the medical staff varies depending on the patient type and the medical staff type (the type of a medical staff). For example, in a case where the patient type is the “outpatient”, the medical care processes related to the hospital admission or the surgery (e.g. the hospital admission reservation and the application for surgery illustrated in FIG. 13) are unnecessary. In a case where the medical staff type is a “dietician”, the medical care processes that are not illustrated in FIG. 13 (e.g. creating hospital meal plans for the inpatients and providing dietary instructions to the inpatients) are necessary. Thus, the items displayed in the item display section 76 of the patient list 71 vary according to the patient type and the medical staff type as illustrated in an item list 84 organized according to the patient types and the medical staff types in FIG. 14.

In FIG. 14, for example, in a case where the patient type is the “surgery scheduled patient” and the medical staff type is the “doctor”, the items displayed in the item display section 76 are the name of the disease, the hospital admission reservation, the examination, the request for anesthesia, the preoperative summary, the application for surgery, the consent for anesthesia, the consent for surgery, and the like shown in FIG. 13. For example, in a case where the patient type is “outpatient”, the items such as “the name of the disease”, “the examination”, and “patient referral” are displayed regardless of the medical staff type. The “patient referral” is a document that describes the medical care information (medical care data) about the outpatient who was referred by a doctor of another medical facility.

For example, in the case where the patient type is the “inpatient” and the medical staff type is the “doctor”, the items such as “name of the disease”, “meal”, “hospital admission reservation”, “examination”, “application for surgery”, “clinical path”, “pressure ulcer management plan”, “nutritional management plan”, “therapeutic plan following discharge”, and “hospital discharge summary” are displayed.

The clinical path is prepared by a doctor and describes the disease of the inpatient, the symptoms thereof, a therapeutic plan, examinations, the descriptions of the surgery and the scheduled date of the surgery, and the estimated period of the hospital admission. The pressure ulcer management plan is prepared by a nurse and describes information about prevention and treatment of pressure ulcer (the so-called bedsore) due to a long-term hospital admission. The nutritional management plan is prepared by a dietician and describes information about hospital meals such as hospital meal plans for the inpatients and nutrition education for the inpatients. The therapeutic plan following discharge is prepared by a doctor and describes the estimated date of the hospital discharge, the condition of the patient at the time of the hospital discharge, the treatment plan following the hospital discharge, precautions in daily life (e.g. rest levels, meals, taking medicine, and taking a bath), and guides to health and welfare services. The hospital discharge summary is a summary of the results of the medical examinations performed during the hospital admission.

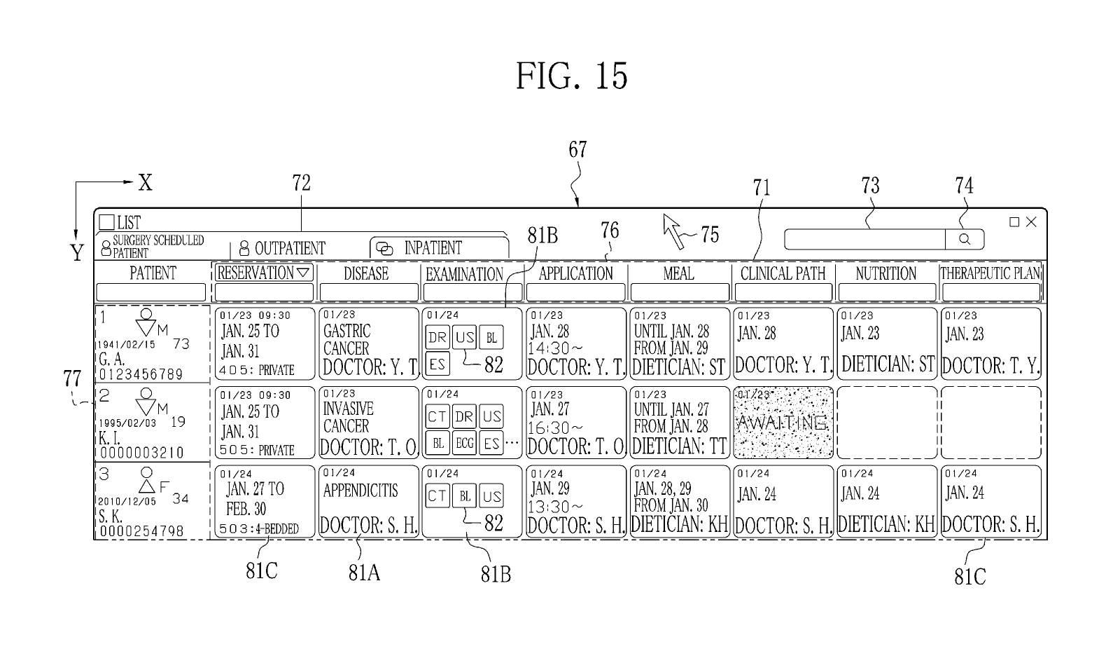

As described above, the items displayed in the item display section 76 vary depending on the medical staff type, so that the progress status information 50 includes (stores) the progress status information 50 for doctors (see FIG. 7) and the progress status information 50 for other medical staffs such as nurses or dieticians. The patient list 71 is generated and edited by the screen editor 48 in accordance with the patient type and the medical staff type. An example in FIG. 15 shows that the medical staff type of a medical staff whose medical staff ID has been inputted through the log-in screen is the “dietician” and a tab 72C (the inpatient) of the patient type selection tab 72 has been chosen.

The item display section 76 of the patient list 71 illustrated in FIG. 15 displays each of the items (disease, meal, reservation for hospital admission (abbreviated as “reservation” in the drawing), examination, application for surgery (abbreviated as “application” in the drawing), clinical path, nutritional management (abbreviated as “nutrition” in the drawing), and therapeutic plan following discharge (abbreviated as “therapeutic plan” in the drawing)) displayed in the description corresponding to the patient type “inpatient” and the medical staff type “dietician” in the item list 84 organized according to patient types and medical staff types shown in FIG. 14. The icons 81 are arranged in a matrix on the intersection points of the above-described items and the pieces of patient information, respectively, in a manner similar to those shown in FIG. 13. The general icon 81C arranged below (in the column corresponding to) the item “meal” displays the dates before and after the surgery, the types of meals (e.g. liquid diet, fasting, or normal meal) (the types of meals are not displayed in the drawings but they are displayed in the actual screen), and the name of the dietician in charge. Each of the icons 81C arranged below the items “clinical path”, “nutritional management”, and “therapeutic plan following discharge” displays the date the document was submitted and the name of the medical staff who prepared the document.

Note that, in the case where the patient type is “outpatient”, the general icon 81C arranged below the item “patient referral” displays the name of the medical facility from which the patient was referred, the name of the doctor who referred the patient, and the like in text form (text information) (not shown). The items are not limited to those described above. For example, items such as “request for blood transfusion”, “consent for blood transfusion”, or the like may be added in a case where the surgery needs blood transfusion. An item “application for ICU (Intensive care unit)” may be added in a case where a patient uses ICU. For example, items of daily medical care processes (e.g. thermometry, pulse measurement, blood pressure measurement, and blood collection) may be added for the medical staff type “nurse”. The items of examinations may vary according to the medical staff type. In the case where the medical staff type is “doctor”, “nurse”, or “laboratory technologist”, all the medical examinations including the imaging examination, the laboratory test, and the physiological test may be displayed as the examination items. In the case where the medical staff type is “dietician”, only the laboratory test may be displayed as the examination item.

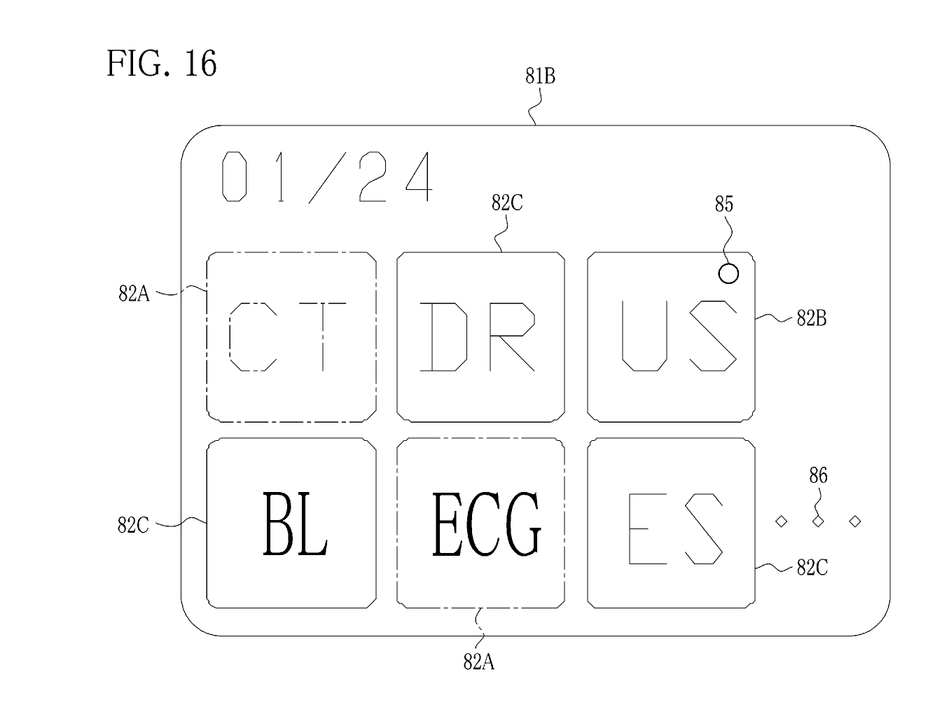

As illustrated in FIG. 16, the screen editor 48 changes the display state of the small icon 82 in accordance with a change in the progress status of the corresponding medical examination. To be more specific, for example, in the case where the progress status is “not performed”, the letters (or characters) and the frame lines of the small icons 82A (for example, “CT” and “ECG”) depicted by chain and dot lines are displayed in an achromatic color (e.g. gray). In the case where the progress status is “not checked”, for example, in the case of the small icon 82B that represents “US”, the letters and the frame lines are displayed in white color and a “not checked” mark 85 is displayed in the small icon 82B. In the case where the progress status is “checked”, for example, in the case of the small icons 82C that represent “DR”, “BL”, and “ES”, the letters and the frame lines are displayed in white.

As illustrated in FIG. 7, whether the progress status of the medical examination is “checked” or “not checked” depends on the medical staff. For example, in the case where “US: D007 not checked” has been recorded in the item “examination” corresponding to the patient ID “0000003210” in the progress status information 50 and the medical staff ID “D007” is inputted through the log-in screen, the “not checked” mark 85 is displayed in the small icon 82 that represents the examination “US” (for example, see the small icon 82B in FIG. 16). In the case where “US: D002 checked” has been recorded in the item “examination” corresponding to the patient ID “0000003210” in the progress status information 50 and the medical staff ID “D002” is inputted through the log-in screen, the “not checked” mark 85 is not displayed in the small icon 82 that represents the examination “US”, and the small icon 82 representing the examination “US” is displayed in the same manner as the small icons 82C representing “DR”, “BL”, and “ES”. Thus, the progress statuses displayed on the patient list 71 vary according to the medical staff.

Note that a numeral 86 denotes an “and so on” mark (ellipsis dots), which is displayed in the case where there are more than six types of medical examinations, in other words, in the case where the number of the small icons 82 is greater than six, which is the maximum number of the small icons 82 displayed at a time in the special icon 82B. In response to choosing the “and so on” mark 86 with the cursor 75, the small icons 82 that have not appeared in the special icon 81B are pop-up displayed over the special icon 81B.

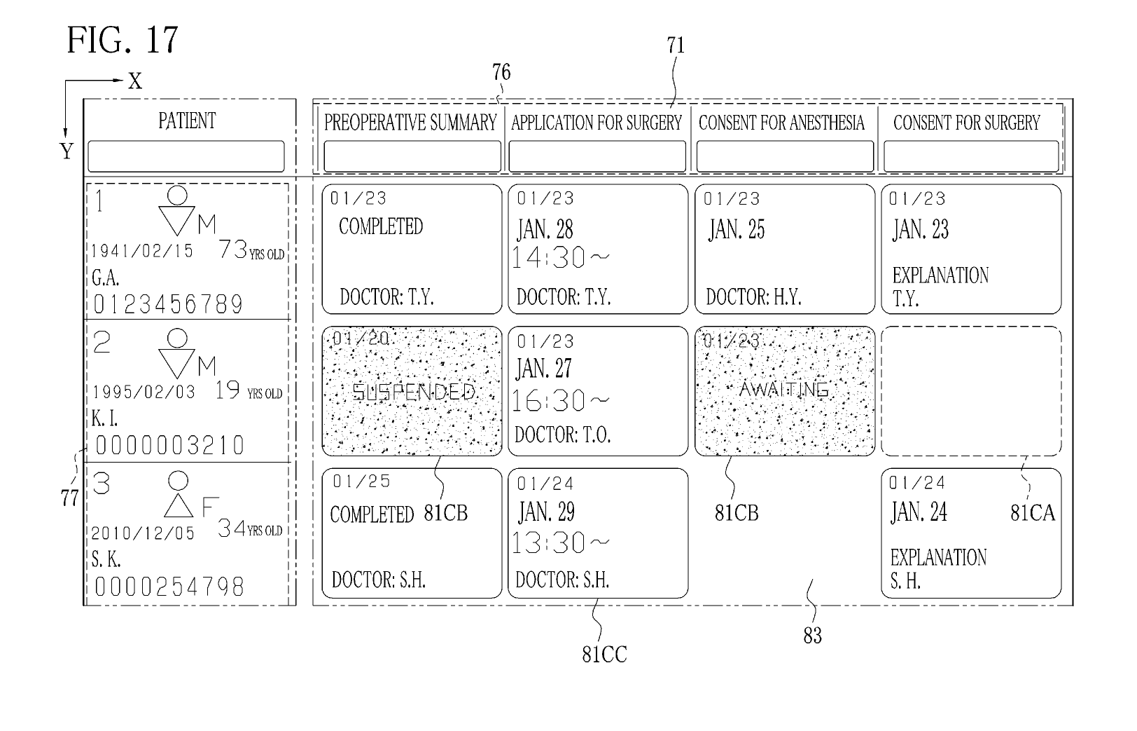

As illustrated in FIG. 17, the screen editor 48 changes the display state of the general icon 81C in accordance with a change in the progress status of the medical care process other than the medical examination. To be more specific, in the case where the progress status is “not started”, the icon is displayed not in the chromatic color set for the icon but in an achromatic color (in this example, white) and the frame lines of the icon are depicted with dotted lines (see, for example, the general icon 81CA depicted with the dotted lines and located at the intersection point of the item “consent for surgery” and the patient ID “0000003210”). In the case where the progress status is “not completed”, the icon is displayed not in the chromatic color set for the icon but in an achromatic color (in this example, gray) and the letters (or characters) in the icon are displayed in white (see, for example, the general icon 81CB with hatch lines (dots) located at each of the intersection point of the item “preoperative summary” and the patient ID “0000003210” and the intersection point of the item “consent for anesthesia” and the patient ID “0000003210”). In the case where the progress status is “completed”, the icon is displayed in the chromatic color set for the icon and the letters in the icon are displayed in white (see, for example, the general icons 81CC corresponding to the patient ID “0123456789” and the general icon 81CC located at the intersection point of the item “application for surgery” and the patient ID “0000003210”.

In the case where the patients are narrowed down by the patient type, the patient information display section 77 of the patient list 71 displays only the patient information of the patients narrowed down by the patient type. The general icon 81C and the small icon 82 display the progress statuses of the medical care processes corresponding to the patients narrowed down. Thus, the patients displayed on the patient list 71 and the progress statuses vary according to the patient type. Note that, before narrowing down the patients by the patient type, the patients of the types “the surgery scheduled patient”, “the outpatient”, and “the inpatient” are mixed in the patient list 71 generated.

Each piece of the patient information in the patient information display section 77 is selectable with the cursor 75. In the case where the patient information is selected with the cursor 75, the command issuer 42 issues an edit request for editing the second display screen 15B in which the results of the medical examination and the medical report 26 of the patient whose patient information has been selected with the cursor 75 are to be displayed. The edit information manager 47 picks up (retrieves) the locations of various types of medical care data corresponding to the patient ID of the patient whose patient information has been selected with the cursor 75, from the storage location information 51. The edit information manager 47 accesses the locations and retrieves the medical care data necessary for generating the second display screen 15B, and transmits the retrieved medical care data to the screen editor 48. Based on the medical care data transmitted from the edit information manager 47, the screen editor 48 edits the second display screen 15B.

In FIG. 18, the second display screen 15B comprises nine display sections 90 to 98: an EMR description display section 90 located in an upper left portion, a laboratory test result display section 91 located in a lower left portion, a DR (digital radiography or plain radiography) result display section 92 located in an upper center portion, a prescription display section 93 and a report display section 94 located in a lower center portion, an ECG (electrocardiogram) result display section 95 located in an upper right portion, a US (ultrasound) result display section 96 located in a right center portion, an ES (endoscopy) result display section 97 located in a lower right portion, and an examination record display section 98 located in a right end portion. The second display screen 15B is a display screen that displays the results of various types of medical examinations and the medical reports 26 as detailed information of the medical care processes.

The second display screen 15B is displayed in place of the first display screen 15A on the display 34B of the client terminal 12 and the display of the first or second display screen 15A or 15B is selectable (switchable). Alternatively, the first and second display screens 15A and 15B may be displayed independently on the display 34B.

The display position, the area, and the display content of each of the display sections 90 to 98 in the second display screen 15B are customized freely by the medical staff and the layout settings are recorded in the layout data 57, in a manner similar to those of the display sections 65 to 67 in the first display screen 15A. For example, the display sections for other medical examinations (e.g. a CT result display section or an MRI result display section) or a display section for displaying the consent for anesthesia, the consent for surgery, or the like may be added.

In the EMR description display section 90, an EMR description display gadget chronologically displays the descriptions (e.g. consultation record data and the like in the EMR 24) (the letters, characters, and descriptions are not displayed in FIG. 18 but they are displayed in the actual screen). In the laboratory test result display section 91, a laboratory test result display gadget chronologically displays the examination results (e.g. the blood test values, the biochemical test values, and the like) and graph(s) indicating changes in test values with time (the dates, the types of tests, the reference values and the measurements of each test are not displayed in FIG. 18 but they are displayed chronologically in the actual screen). In the DR result display section 92, the DR result display gadget displays an X-ray image captured in the DR examination. In the prescription display section 93, a prescription display gadget chronologically displays the prescriptions of the medication based on the order data of the medication and the treatment record data in the EMR 24 (the date and the details of the prescriptions are not displayed in FIG. 18 but they are displayed in the actual screen).

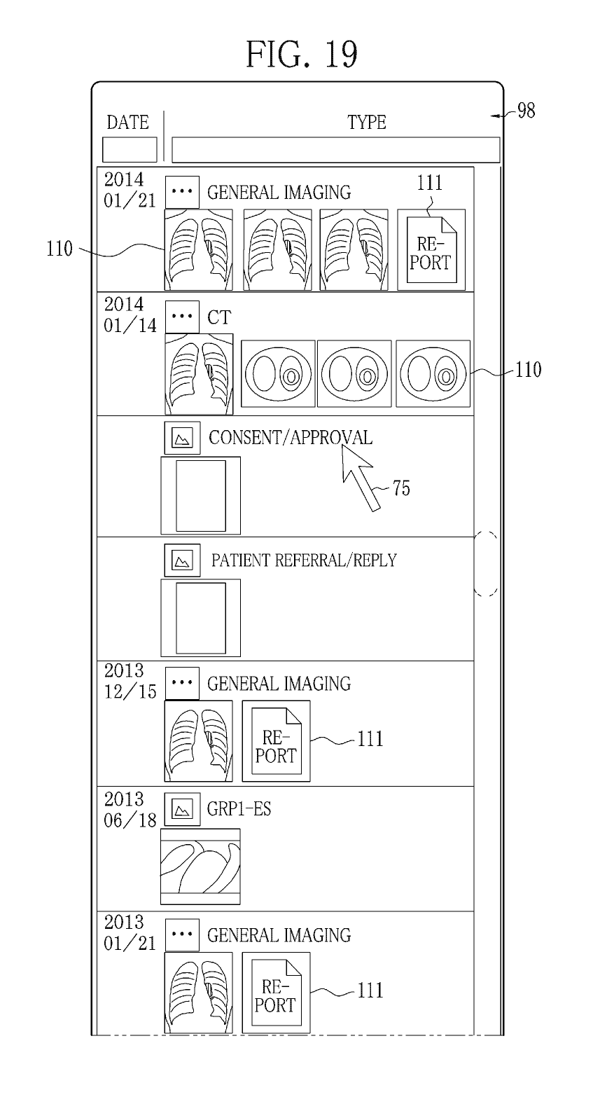

In the report display section 94, a report display gadget displays the medical report 26. In the ECG result display section 95, an ECG result display gadget displays an ECG image captured in the ECG examination (the date and time and the like are not displayed in FIG. 18 but they are displayed in the actual screen). In the US result display section 96, a US result display gadget displays an ultrasonic image captured in the US examination (the date and time and the like are not displayed in FIG. 18 but they are displayed in the actual screen). In the ES result display section 97, an ES result display gadget displays an endoscopic image captured in the ES examination (the date and time and the like are not displayed in FIG. 18 but they are displayed in the actual screen). In the examination record display section 98, an examination record display gadget chronologically displays the records of various types of medical examinations that the patient had (the types of the medical examinations and the like are not displayed in FIG. 18 but they are displayed in the actual screen and the examination record display section 98 is enlarged and displayed in FIG. 19). The above-described gadgets are a part of the gadgets included in the viewer software 40. Note that each of the display sections 90 to 98 may be enlarged and displayed to cover the entire second display screen 15B.

In the examination record display section 98 shown in FIG. 19, the records of various types of medical examinations are listed chronologically with the medical examination of the latest date and time listed on the top. In the record of each medical examination, time and date of the medical examination, a thumbnail icon 110 of the examination image 25, and a link icon 111 for the medical report 26 are displayed. The record of the medical examination with the progress status “not performed” is not displayed and hence the corresponding icons 110 and 111 are not displayed in the examination record display section 98.

In the case where the thumbnail icon 110 is chosen with the cursor 75, the examination image 25 corresponding to the chosen thumbnail icon 110 is displayed in the corresponding examination result display section. For example, in the case where the thumbnail icon 110 of an X-ray image is chosen, the X-ray image corresponding to the chosen thumbnail icon 110 is displayed in the DR result display section 92. In the case where the link icon 111 is chosen with the cursor 75, the medical report 26 corresponding to the chosen link icon 111 is displayed in the report display section 94. A command for choosing the icon 110 or 111 is issued as the edit request by the command issuer 42.

In the DS result display section 92, the US result display section 96, and the ES result display section 97, which are displayed in the second display screen 15B displayed in response to selecting the patient information with the cursor 75, the examination images 25 captured in the latest medical examinations are displayed. In the ECG result display section 95 and the report display section 94, the ECG image captured in the latest ECG examination and the corresponding medical report 26 are displayed, respectively.

In the case where the edit information manager 47 receives the edit request that is issued in response to choosing the patient information or choosing the link icon 111, from the command receiver 46, the edit information manager 47 determines that the medical staff logged in has finished checking the medical report 26. In the case where the progress status of the item “examination” of the progress status information 50 corresponding to the medical staff logged-in is “not checked”, the edit information manager 47 changes the progress status to “checked”.

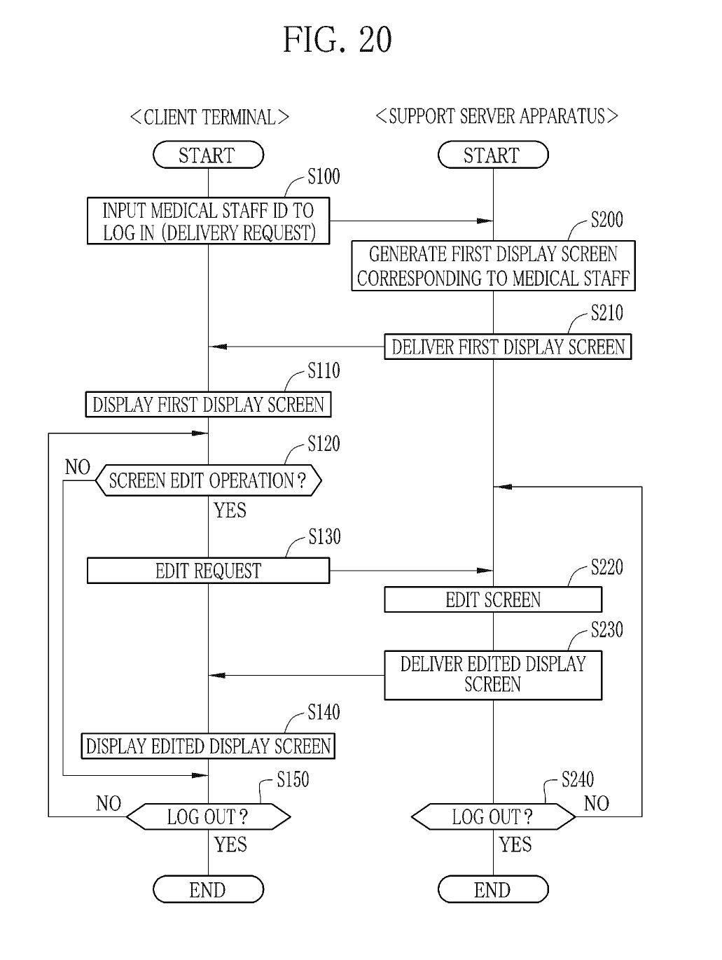

Hereinafter, referring to a flowchart in FIG. 20, an operation of the above-described configuration is described. First, the medical staff operates the client terminal 12 to start the viewer software 40. Upon the startup of the viewer software 40, the GUI controller 41 and the command issuer 42 are constructed in the CPU 32B of the client terminal 12.

As shown in FIG. 20, 5100 describes that the medical staff inputs the medical staff ID through the log-in screen, to view the first display screen 15A. Thereby the command issuer 42 issues the delivery request for the first display screen 15A.

The operation program 45 starts up in the medical support server apparatus 11, so that the command receiver 46, the edit information manager 47, the screen editor 48, and the delivery controller 49 are constructed in the CPU 32A. Thereby the medical support server apparatus 11 functions as the medical support apparatus.

The command receiver 46 of the medical support server apparatus 11 receives the delivery request issued from the command issuer 42 of the client terminal 12. The delivery request is provided (transmitted) to the edit information manager 47. The edit information manager 47 picks up (retrieves) the edit information 16 that is necessary for generating the first display screen 15A from the edit information DB 11A, for example, the edit information manager 47 retrieves the progress status information 50 necessary for generating the patient list 71. The edit information 16 retrieved by the edit information manager 47 is provided (transmitted) to the screen editor 48.

The screen editor 48 generates the first display screen 15A based on the edit information 16 provided by the edit information manager 47 (S200). At this time, the screen editor 48 changes the display state of the small icon 82 in accordance with a change in progress status of the corresponding medical examination as illustrated in FIG. 16. As illustrated in FIG. 17, the display state of the general icon 81C is changed in accordance with a change in progress status of the corresponding medical care process other than the medical examination. The delivery controller 49 delivers the generated first display screen 15A to the client terminal 12 (S210).

The GUI controller 41 displays the first display screen 15A on the display 34B of the client terminal 12 (S110). The first display screen 15A displays the patient list 71, which includes the special icons 81B. In each special icon 81B, two or more small icons 82 are disposed. Each small icon 82 represents the progress status of the corresponding medical examination.

Under the constraint that the display area of the patient list 71 is limited in the horizontal axis X direction, the small icons 82, each of which represents the progress status of the corresponding medical examination, are displayed compactly in size in the special icon 81B. Thereby the increase in width of the item display section 76 in the horizontal axis X direction is prevented. An additional operation such as operating the horizontal scrollbar to take a glimpse of the entire progress statuses of the medical care processes is eliminated. Thus, the need of the medical staffs to check as many progress statuses of the medical care processes as possible at a time without extra effort and time has been met.

The small icons 82 represent the progress statuses of the medical care processes of the same category (the medical examinations in this example). The small icons 82 are put together in one special icon 81B, so that the progress statuses of the medical care processes of the same category (various types of medical examinations) are checked at a glance. Thereby the progress status of each medical examination is noticed easily as compared with that of the case where the icons representing the progress statuses of various medical examinations are scattered throughout the patient list 71. Thus the perspicuity (clarity) of the progress statuses of the various medical examinations is improved. Since there are many types of medical examinations (e.g. imaging examinations, laboratory tests, and physiological tests), the advantage in checking the progress statuses at a glance is made full use of.

The patient list 71 also displays the general icon 81C the same size as the special icon 81B. The general icon 81C represents the progress status of the medical care process other than the medical examination. The general icon 81C displays various types of text information about the medical care process (e.g. the date and time of the medical care process performed, the scheduled date and time of the medical care process to be performed, the type of the medical care process, the medical staff who is scheduled to perform the medical care process or who has performed the medical care process, a reason for suspending the medical care process, and the like). The small icon 82 also displays the text information that denotes the type of the medical examination. Hence, the information about the medical care processes is conveyed adequately to the medical staffs, contributing to the efficiency of the team medicine.

The icons 81 may be composed of the special icons 81B only. In this case, however, it may become difficult to check and comprehend the content of the medical care processes. In this embodiment, the special icons 81B are limited to those representing the progress statuses of the medical care processes of the same category. The progress statuses of the remaining medical care processes are represented by the general icons 81C. Thereby the patient list 71 makes it easy to grasp the progress statuses as a whole.

The small icon 82 represents the progress status “not performed”, “not checked”, or “checked”. The progress status “not performed” corresponds to the state in which the medical examination has not been performed. The progress status “not checked” corresponds to the state in which the medical examination has been performed but the medical report 26 has not been checked. The progress status “checked” corresponds to the state in which the medical report 26 has been checked. For example, in the case where the medical staff is a laboratory technologist and the progress status represented by the small icon 82 is “not performed”, the small icon 82 prompts the laboratory technologist to perform the medical examination as soon as possible. In the case where the medical staff is a doctor and the progress status represented by the small icon 82 is “not checked”, the small icon 82 prompts the doctor to check the medical report 26 as soon as possible.

The general icon 81C represents the progress status “not started”, “not completed”, or “completed”. The progress status “not started” corresponds to the state in which the medical care process has not been started. The progress status “not completed” corresponds to the state in which the medical care process has been started but has not been completed. The progress status “completed” corresponds to the state in which the medical care process has been completed. In the case where the progress status represented by the general icon 81C is “not started” or “not completed”, the general icon 81C prompts the medical staff to start or complete the medical care process as soon as possible, in a manner similar to the small icon 82.

The general icon 81C and the small icon 82 are displayed only for the medical care processes that are scheduled to be performed. A medical care process that is unnecessary or not performed is left as the blank space 83. Thereby the medical care processes that are scheduled to be performed and those that are unnecessary (not performed) are seen at a glance. Errors such as performing an unnecessary medical care process are prevented.

The patient list 71 is generated in accordance with the medical staff. The items displayed in the item display section 76, the patients displayed in the patient information display section 77, and the progress statuses of the medical care processes represented by the icons 81 vary according to the medical staff. Thereby each medical staff is positively informed of the progress statuses of the medical care processes of the patients whom he/she is in charge of. Each medical staff becomes aware of what to prepare and what to do in the medical care processes and smoothly proceeds with the medical care processes.

The medical staff views the first display screen 15A and checks the progress status of each medical care process of each patient. The medical staff operates the patient type selection tab 72 or the like as necessary to narrow down the patients displayed on the patient list 71 by the patient type, operates the page select button group 80 to switch the page of the patient list 71, or selects the patient information in the patient information display section 77 to display the second display screen 15B. In the case where such screen edit operation is performed (YES in S120), the edit request is issued from the command issuer 42 (S130).

The edit request, which is issued by the command issuer 42 of the client terminal 12, is accepted (received) by the command receiver 46 of the medical support server apparatus 11 and then provided to the edit information manager 47. The edit information manager 47 picks up (retrieves) the edit information 16 necessary for editing the screen from the edit information DB 11A. The edit information 16 retrieved by the edit information manager 47 is provided to the screen editor 48.

Based on the edit information 16 from the edit information manager 47, the screen editor 48 edits the screen (S220). For example, in the case where the edit request from the command receiver 46 is an edit request for editing the second display screen 15B, the second display screen 15B is edited based on the various types of medical care data provided by the edit information manager 47. The delivery controller 49 delivers the edited first display screen 15A or the edited second display screen 15B to the client terminal 12 (S230).

The GUI controller 41 of the client terminal 12 displays the edited first display screen 15A or the edited second display screen 15B on the display 34B (S140). The medical staff views the second display screen 15B to check the result of each medical examination and each medical report 26, which is the report on the result of the medical examination, at a glance. When or after the medical staff views the second display screen 15B, the edit information manager 47 changes the progress status of the item “examination” of the progress status information 50 to “checked” in the case where the progress status of the item “examination” corresponding to the medical staff viewing the second display screen 15B is “not checked”.

In the case where the edit request from the command receiver 46 is an edit request to narrow down the patients displayed in the patient list 71 by the patient type, the patient list 71 is generated in accordance with the patient type chosen. The items displayed in the item display section 76, the patients displayed in the patient information display section 77, and the progress statuses of the medical care processes represented by the icons 81 in the patient list 71 vary according to the patient type. Thus, the progress statuses of the medical care processes corresponding to the patient type are comprehended at a glance.

The client terminal 12 repeats the above-described steps (S120 to S140) while the command to log out is not provided by the medical staff (NO in S150). In a like manner, the medical support server apparatus 11 repeats the above-described steps (S220 and S230) while the command receiver 46 receives no command to log out (NO in S240).

Note that, FIG. 20 describes an example of a procedure for the case in which one client terminal 12 and one medical support server apparatus 11 are used. Actually, the medical support server apparatus 11 receives the delivery requests and the edit requests from two or more client terminals 12, generates the first display screens 15A of the client terminals 12, edits the first and second display screens 15A and 15B of the client terminals 12, and delivers the first and second display screens 15A and 15B to the client terminals 12 at the same time.

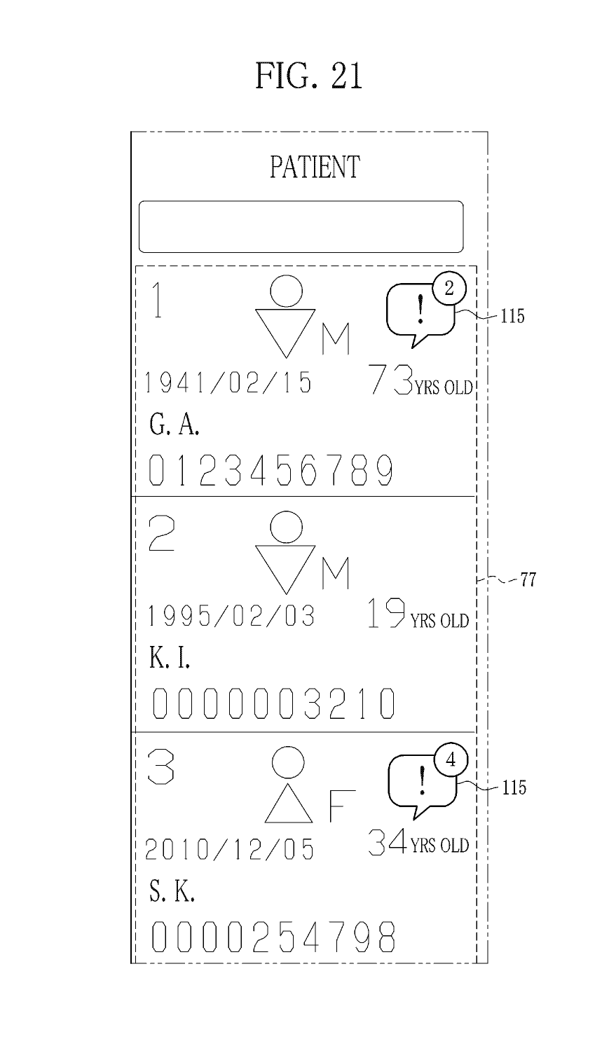

In addition to the display of the progress status “not checked” with the small icon 82B showing the “not checked mark” 85, a speech balloon mark 115 may be displayed in the corresponding patient information (with the progress status “not checked”) in the patient information display section 77 as illustrated in FIG. 21. The speech balloon mark 115 represents the number of the medical examinations with the progress status “not checked”. The small icon 82 is small in size. The progress status “not checked” represented by the small icon 82 may be overlooked in the case where the number of the small icons 82 exceed the maximum number that can be displayed at a time in the special icon 81B because the small icons 82 exceeding the maximum number are not displayed unless the “and so on mark” 86 is chosen. The display of the speech balloon mark 115 prevents the error of overlooking the progress status “not checked”.

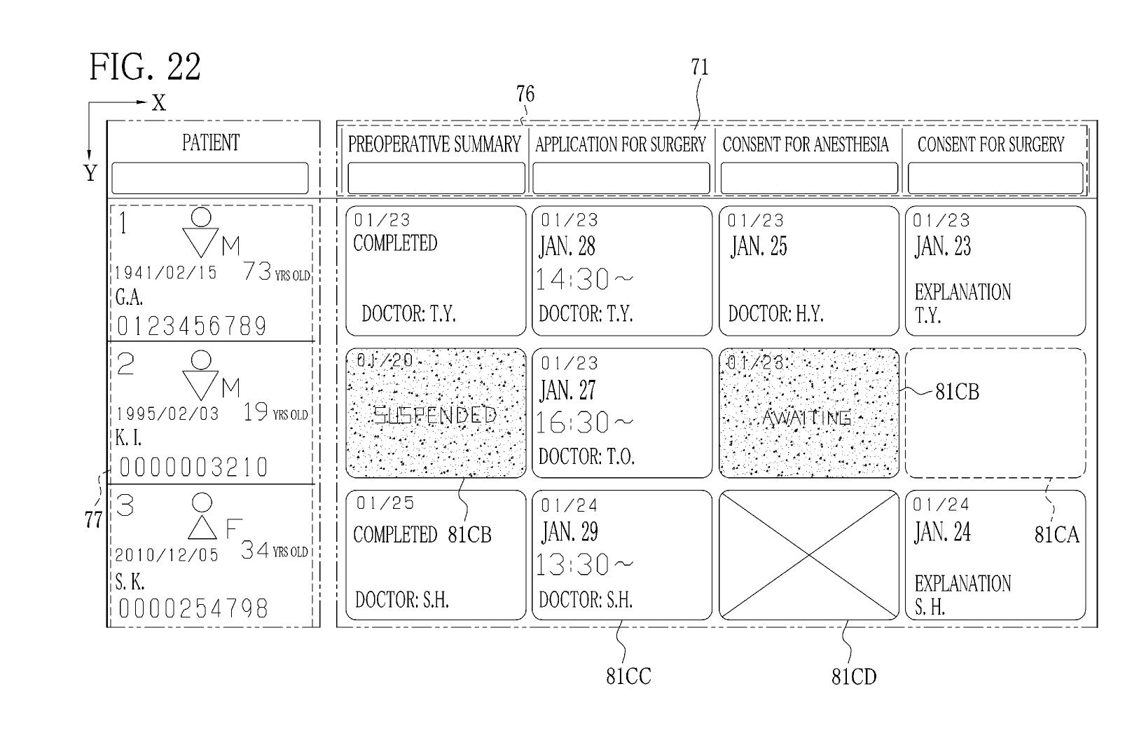

In the above embodiment, an unnecessary medical care process (e.g. the item “consent for anesthesia” corresponding to the patient ID “0000254798” or the like), which is not performed, is left as the blank space 83 in the patient list 71. Instead, the general icon 81C may be used to represent such unnecessary medical care process. As shown in FIG. 22, for example, a general icon 81CD with a cross mark represents the unnecessary medical care process (e.g. the item “consent for anesthesia” corresponding to the patient ID “0000254798”). The general icon 81CD is displayed differently from the general icons 81C (general icons 81CA, 81CB, and 81CC) that represent the medical care processes to be performed, so that the general icon 81CD is distinguished from the general icons 81C (the general icons 81CA, 81CB, and 81CC). Thereby the medical care processes to be performed are clearly distinguished from the unnecessary medical care processes, which are not performed.

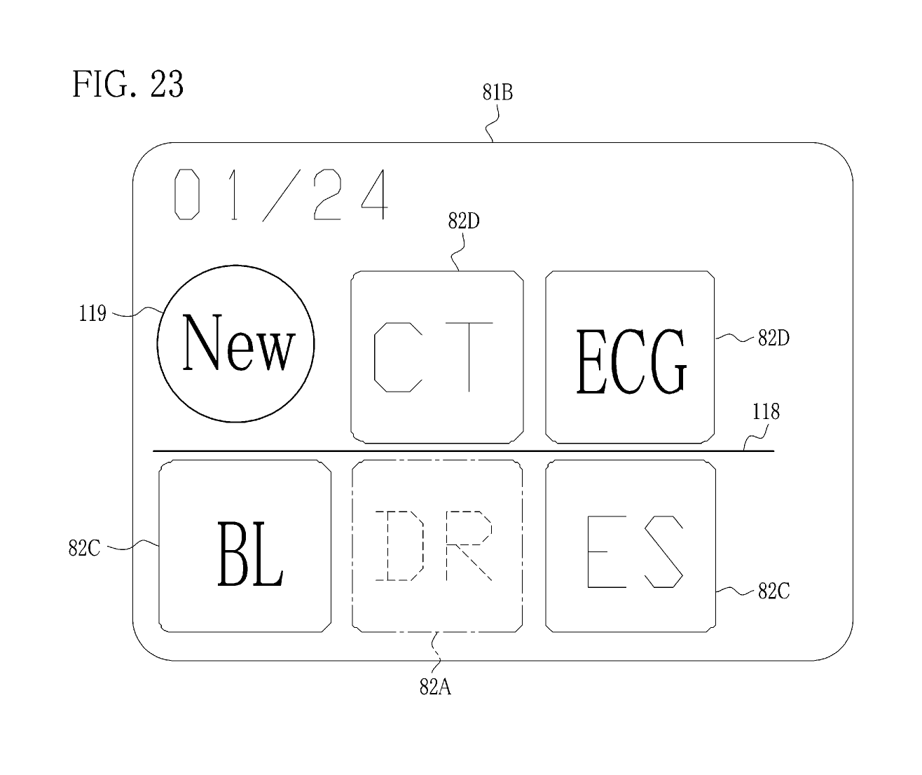

In the above embodiment, a change in progress status of the medical examination is represented by a change in color or line type (or a frame line) of the small icon 82 or by displaying the mark (e.g. the “not checked mark” 85). A change in progress status may be represented in a different way. For example, as illustrated in FIG. 23, a change in progress status of the medical examination may be represented by changing the display position of the small icon 82 in the special icon 81B.

In FIG. 23, a boundary 118 is displayed in the special icon 81B. The boundary 118 separates the display area, in which the small icons 82 are displayed, in half into upper and lower portions. In the lower portion below the boundary 118, the small icon 82A representing the examination “DR (digital radiography)” with the progress status “not performed”, the small icon 82C representing the examination “BL (blood test)” with the progress status “checked”, and the small icon 82C representing the examination “ES (endoscopy)” with the progress status “checked” are disposed. In the upper portion above the boundary 118, the small icon 82D representing the examination “CT (computed tomography)” with the progress status “not checked” and the small icon 82D representing the examination “ECG (electrocardiogram)” with the progress status “not checked” are disposed. In addition, a new mark 119 is displayed in the upper portion. The new mark 119 represents that the progress status is “not checked”. The shape of the small icons 82D (representing “CT” and “ECG” each with the progress status “not checked”) is the same as that of the small icons 82C (representing “BL” and “ES” each with the progress status “checked”). However, the small icons 82D (“CT”, “ECG”) with the progress status “not checked” are disposed in the upper portion of the boundary 118, so that the small icons 82D (“CT”, “ECG”) are distinguished from the small icons 82C (“BL”, “ES”) with the progress status “checked” disposed in the lower portion of the boundary 118. Representing the changes in progress statuses of the small icons 82 by changing the display positions of the small icons 82 is possible for the special icon 81B, in which a plurality of small icons 82 are disposed. Thus the progress status of each medical care process is displayed more clearly.

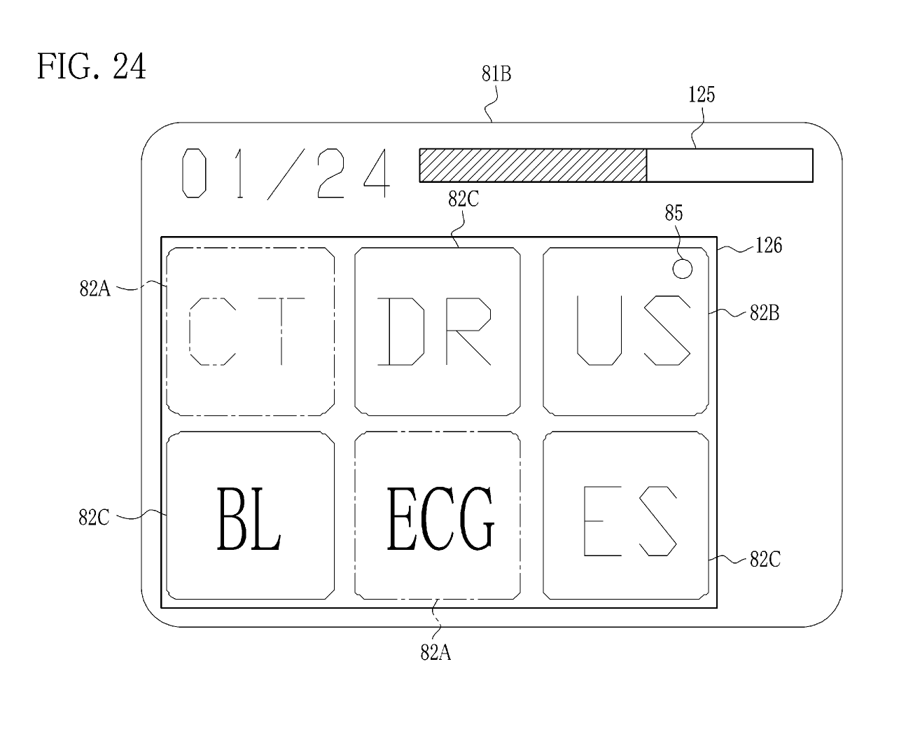

A progress bar 125 shown in FIG. 24 may be used as a mark representing the progress status. FIG. 24 illustrates an example in which the progress bar 125 is displayed in the special icon 81B. In this case, each small icon 82 represents a change in progress status of the corresponding medical examination while the progress bar 125 represents a change in the progress statuses of the medical examinations, which are represented by the small icons 82, as a whole. In the case where the progress bar 125 indicates less than 100%, a white frame 126 is displayed to surround all of the small icons 82 to enhance the display of the small icons 82, by way of example.

For example, in the case where there are four types of medical examinations whose progress statuses are represented by the small icons 82 and the progress statuses of all of the four types of medical examinations are “not performed”, the progress bar 125 indicates 0%. In the case where the progress statuses of the two types of medical examinations are “not performed” and the progress statuses of the two types of medical examinations are “checked”, the progress bar 125 indicates 50%. In the case where the progress statuses of all of the four types of medical examinations are “checked”, the progress bar 125 indicates 100%.

Of the progress statuses of six types (“CT”, “DR”, “US”, “BL”, “ECG”, and “ES”) of medical examinations, the progress statuses of the three types (“DR”, “BL”, and “ES”) of the medical examinations are “checked”, the progress statuses of the two types (“CT” and “ECG”) of the medical examinations are “not performed”, and the progress status of the medical examination “US” is “not checked” in an example shown in FIG. 24. Hence the progress bar 125 indicates approximately 60%.

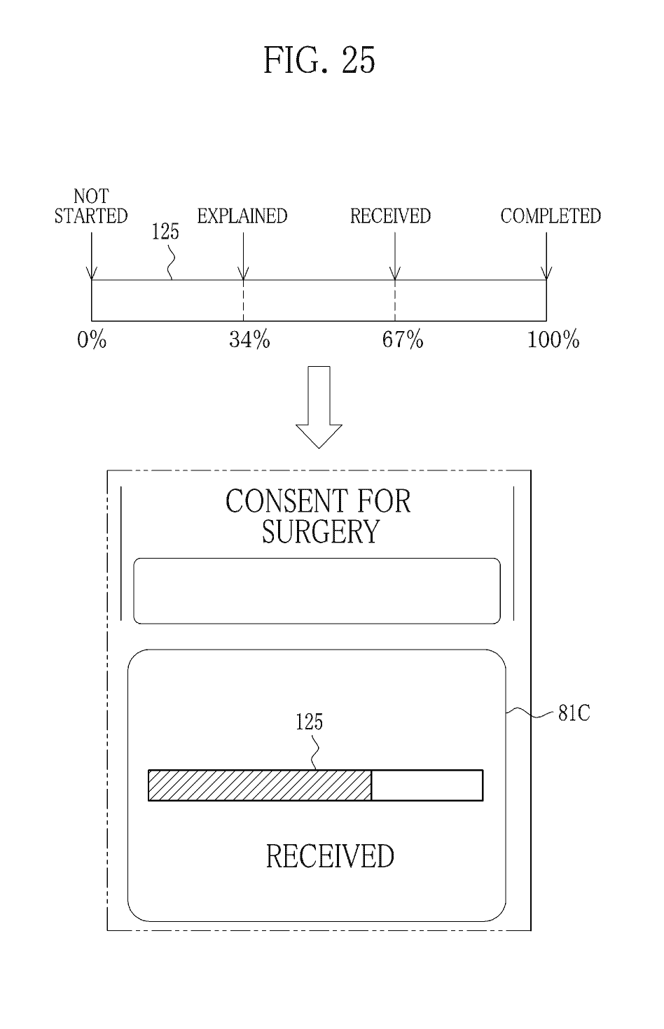

FIG. 24 illustrates an example in which the progress bar 125 is displayed in the special icon 81B. As illustrated in FIG. 25, the progress bar 125 may be displayed in the general icon 81C.

FIG. 25 illustrates an example in which the progress bar 125 is provided in the general icon 81C disposed below the item “consent for surgery”. In this case, as illustrated in an upper portion of FIG. 25, the progress status of the medical care process “consent for surgery” is subdivided into four steps: “not started”, “explained”, “received”, and “completed”. The indication on the progress bar 125 is previously set such that the progress bar 125 indicates 0% in the case where the progress status is “not started”, 34% in the case where the progress status is “explained”, 67% in the case where the progress status is “received”, and 100% in the case where the progress status is “completed”. A change in the progress bar 125 according to the above-described settings shows a change in progress status of the medical care process, “consent for surgery”, by way of example. In FIG. 25, the progress bar 125 indicates 67%, representing that the progress status is “received”. Representing the progress status of the medical care process with the progress bar 125 allows intuitive comprehension of the progress status of the medical care process.

Here, the progress status “not started” represents the state in which the medical care process has not been started, similar to the above embodiment. The progress status “explained” represents the state in which the doctor has explained to the patient or his/her family what the “consent for surgery” is and that the patient or his/her family needs to sign the “consent for surgery”. The progress status “received” represents the state in which the doctor has received the signed consent for surgery from the patient or his/her family. The progress status “completed” represents the state in which the signed consent for surgery has been uploaded to the EMR 24.

Note that the progress bar 125 itself may disappear in the case where the progress bar 125 indicates 100%. A change in progress status may be represented differently in accordance with the medical staff type. For example, the progress bar 125, which represents the progress status of the medical examination, may be displayed only for the radiologists. The schedule of daily medical care processes may be recorded in the schedule management data 55. The progress bar 125 may be displayed only in the icon 81 representing the medical care process(es) scheduled for the day.

Note that, for example, loading animation, in which the color inside an annular shape changes in gradation, may be used as a mark (sign) for representing the progress status or the like.

A change in progress status may be represented by a change in size of the small icon 82. For example, the size of the small icon 82 is greater in the case where the progress status is “not performed” or “not checked” than in the case where the progress status is “checked”. Thereby the medical examination with the progress status “not performed” or “not checked” is made conspicuous. In this case, the sizes of all the small icons 82 in one special icon 81B may become equal when all the progress statuses of the medical examinations represented by the small icons 82 are “checked”. In the case where the progress status is other than “completed” or “checked”, the progress status may be represented by the swaying general icon 81C or the swaying small icon 82 with animation effect or the like, to show the change (or difference) in the progress status.

As illustrated in the example in FIG. 25, the progress statuses represented by the general icon 81C are not limited to the three types, “not started”, “not completed”, and “completed” described in the above embodiment. The progress statuses represented by the small icons 82 are not limited to the three types, “not performed”, “not checked”, and “checked”. For example, the progress status “not completed” may be a case where the medical care process is suspended due to an obstacle or uncontrollable circumstances (e.g. the item “preoperative summary” corresponding to the patient ID “0000003210” in FIG. 7, that is, the medical care process is suspended because another disease has been found and the patient is having medical treatment for the disease found) or a case where the medical care process is suspended without obstacle (e.g. simply due to waiting for the patient's submission of the consent for surgery). The progress status “not completed” may be separated into “suspended” (suspended due to an obstacle or uncontrollable circumstances) and “awaiting” (suspended without obstacle).

With regard to the progress status represented by the small icon 82, the progress status “examination is underway”, which corresponds to a period after the order is checked (S11) and before the report is uploaded (S16) shown in FIG. 8, may be added in addition to the above-described statuses “not performed”, “not checked”, and “checked”. The progress status “report preparation is underway”, which corresponds to a period after the examination result is uploaded (S14) and before the report is uploaded (S16) shown in FIG. 8, may be used. The progress status “image not checked”, which corresponds to a period after the examination result is uploaded (S14) and before the report is prepared (S15) shown in FIG. 8, may be used.

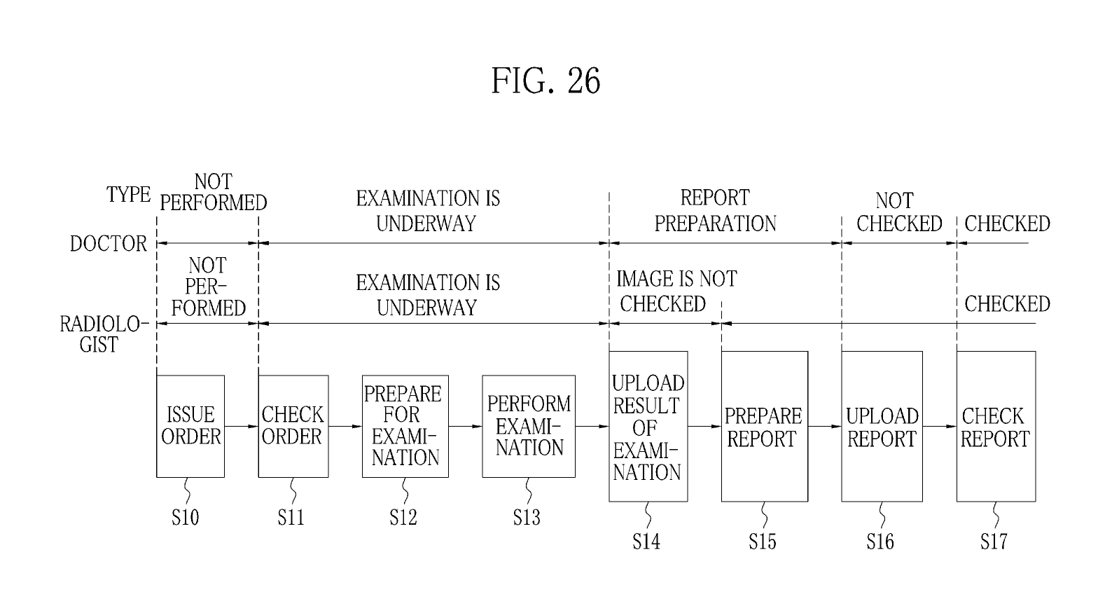

The progress status represented by the small icon 82 may vary according to the medical staff type. The display of the progress status may vary according to each medical staff. In a top portion of FIG. 26, in the case of a doctor who issues an order, for example, the progress status corresponding to a period after the order is issued (S10) and before the order is checked (S11) is referred to as “not performed”. The progress status corresponding to a period after the order is checked (S11) and before the examination result is uploaded (S14) is referred to as “examination is underway”. The progress status corresponding to a period after the examination result is uploaded (S14) and before the report is uploaded (S16) is referred to as “report preparation”. The progress status corresponding to a period after the report is uploaded (S16) and before the report is checked (S17) is referred to as “not checked”. The progress status corresponding to a period after the report is checked (S17) is referred to as “checked”.

In the case of the medical staff type “radiologist”, who prepares the medical report 26, the progress statuses “not performed” and “examination is underway” are the same as those of the medical staff type “doctor”. The progress status corresponding to a period after the upload of the examination result (S14) and before the preparation of the report (S15) is referred to “image is not checked”. The progress status corresponding to a period after the preparation of the report (S15) is referred to as “checked”. As described above, the progress status represented by the small icon 82 is varies according to the medical staff type, so that the progress status displayed is precise and suitable for the corresponding medical staff type. The progress status represented by the general icon 81C may vary according to the medical staff type, in a like manner.

In the above embodiment, the special icon 81B is described by way of example. The special icon 81B in the above-described example contains the small icons 82, which represent the progress statuses of the medical care processes of the same category (e.g. “medical examination”). Two or more small icons 82 contained in one special icon 81B may not represent the progress statuses of the medical care processes of the same category. However, in the case where the small icons 82 do not represent the progress statuses of the medical care processes of the same category, the display of the progress statuses may become complicated because the small icons 82 displayed have no commonality among them. Therefore it is preferred that two or more small icons 82 contained in one special icon 81B represent the progress statuses of the medical care processes of the same category.

Note that another example of the medical care processes of the same category may be the medical care processes “consent for anesthesia” and “consent for surgery”. The medical care processes of the same category may be the medical care processes for measuring the vital signs (e.g. the heart rate, the pulse rate, the blood pressure, the body temperature, and the like of a patient).

In the above embodiment, the second display screen 15B is displayed in a case where one of the pieces of the patient information in the patient information display section 77 is chosen with the cursor 75. Alternatively, the general icon 81C, the small icon 82, or the speech balloon mark 115, which represents the number of the medical examinations with the progress status “not checked”, shown in FIG. 21 may be chosen with the cursor 75. The second display screen 15B may be displayed in response to choosing the general icon 81C, the small icon 82, or the speech balloon mark 115, with the cursor 75.

In addition to the doctors, the laboratory technologists, the nurses, and the dieticians, the medical staffs may include physical therapists who help the patients to rehabilitate and pharmacists who prescribe medicine and instruct the patients how to take it. As illustrated in FIG. 26 byway of example, the types of the medical staffs may be further subdivided in accordance with the tasks or job types. For example, the medical staff type “doctor” may be subdivided into “clinician” who diagnoses and treats the patient and “radiologist” who prepares the medical report 26. For example, the medical staff type “laboratory technologist” may be subdivided into “radiologic technologist” and “sonographer”.

In the above embodiment, the items displayed on the patient list 71, the patient identification information, and the progress statuses vary according to the patient of whom the medical staff is in charge and the medical care process of which the medical staff is in charge. Instead, at least one of the items displayed, the patient identification information, and the progress statuses may vary according to the patient of whom the medical staff is in charge and the medical care process of which the medical staff is in charge. The items displayed on the patient list 71, the patient identification information, and the progress statuses vary according to the patient type. Instead, one of the items displayed, the patient identification information, and the progress statuses may vary according to the patient type.

Not all of the medical examinations (e.g. the imaging examination, the laboratory test, and the physiological test) may be represented (or displayed) by the small icons 82. At least one of the medical examinations may be displayed by using the small icon 82. The patient type may include “home care patient”, who is treated at home.

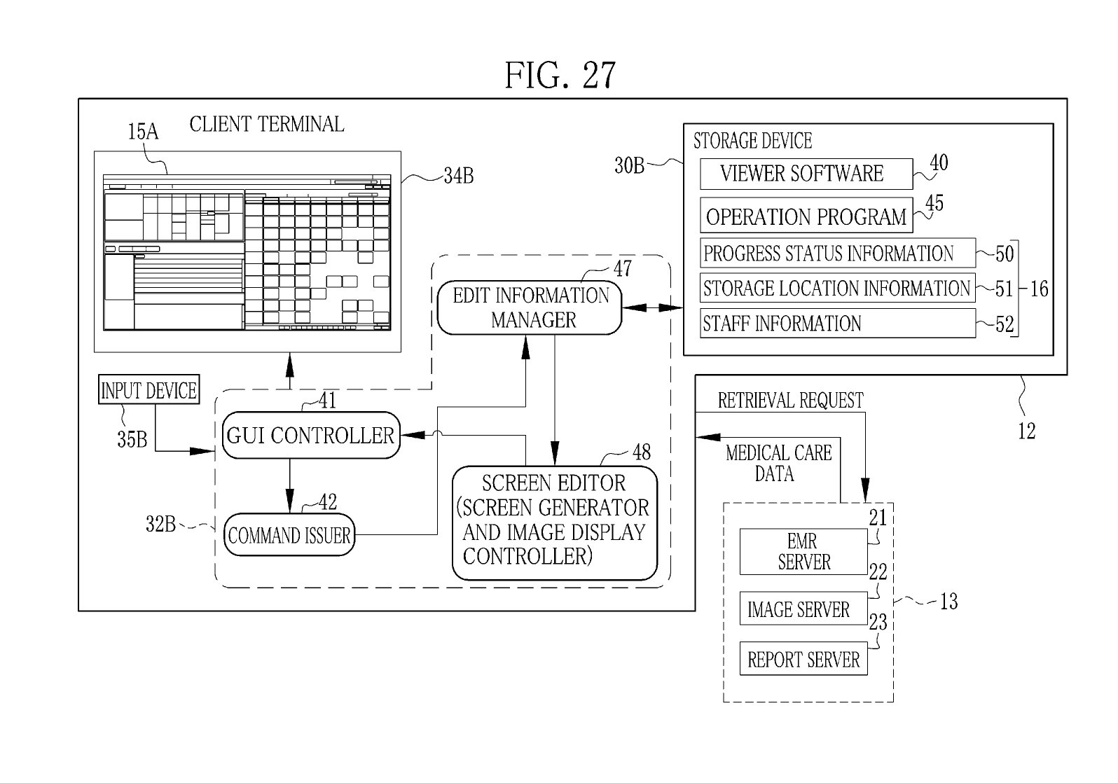

In the above embodiment, the medical support apparatus according to an aspect of the present invention is described as the medical support server apparatus 11, which delivers the first display screen 15A to the client terminal 12 in response to the delivery request. Alternatively, as illustrated in FIG. 27, the client terminal 12 may function as the medical support apparatus. Note that, in FIG. 27, the parts similar to or the same as those in the above embodiment are designated by the same numerals as those in the above embodiment and the descriptions thereof are omitted.

The differences between the example illustrated in FIG. 27 and the above embodiment are that (1) the operation program 45 is stored in the storage device 30B of the client terminal 12 and the CPU 32B of the client terminal 12 executes the operation program 45, so that the CPU 32B functions as the edit information manager 47 and the screen editor 48 and (2) the edit information 16 is stored in the storage device 30B.

In this case, the command issuer 42 issues various types of processing requests to the edit information manager 47. The edit information manager 47 directly accesses the server group 13 to retrieve the medical care data. Based on the retrieved medical care data, the edit information manager 47 updates the progress status information 50 and the storage location information 51 in the storage device 30B.

The screen editor 48 generates the first display screen 15A based on the edit information 16 in the storage device 30B and transmits the first display screen 15A to the GUI controller 41. The GUI controller 41 allows the display 34B to display the first display screen 15A. Based on the edit request issued by the command issuer 42, the screen editor 48 edits the display contents of the first display screen 15A and the second display screen 15B. Thus the medical support apparatus is not limited to the medical support server apparatus 11 described in the above embodiment. For example, the client terminal 12 may be used as the medical support apparatus as illustrated in FIG. 27.

In the above embodiment, the edit information manager 47 issues the retrieval request, which requests the retrieval of the medical care data, to the server group 13 at regular time intervals. In response to the retrieval request, the edit information manager 47 obtains the medical care data transmitted from the server group 13. The embodiments of the present invention are not limited the above. The edit information manager 47 may issue the retrieval request for the medical care data at the timing at which the first display screen 15A and the second display screen 15B are generated and edited. In this case, the medical support server apparatus 11 may not have the edit information DB 11A and generates the progress status information 50 and the storage location information 51 of the edit information 16 every time the medical care data, which is transmitted from the server group 13, is obtained. The retrieval request may not be issued by the edit information manager 47. For example, the updated medical care data may be automatically transmitted from the server group 13 every time the medical care data is updated.

The medical support server apparatus 11 may carry out apart of the functions of the medical support apparatus. The client terminal 12 may carry out another part of the functions of the medical support apparatus. For example, the first display screen 15A may be generated by the medical support server apparatus 11 and edited by the client terminal 12. In this case, a computer system comprised of the client terminal 12 and the medical support server apparatus 11 functions as the medical support system. The medical support apparatus and the medical support system according to the aspects of the present invention are implemented in various embodiments.

The hardware configuration of the computer system such as that of the medical support server apparatus 11 and the client terminal 12 may be modified in various ways. For example, the medical support server apparatus 11 may be comprised of two or more server computers that are independent from each other as hardware. Thus, the hardware configuration of the computer system may be changed as necessary in accordance with the required performance (e.g. throughput (processing capacity), safety, and reliability).

In addition to the hardware, the application programs (e.g. the operation program 45) may be backed up or distributed and stored in two or more storage devices, to ensure safety and reliability.

In the above embodiments, the medical support server apparatus 11 and the client terminal 12 are used in one medical facility, by way of example. For example, one medical support server apparatus 11 may be installed in a data center located outside the medical facility so that the client terminals 12 in two or more medical facilities are capable of using the application services (e.g. the data delivery service) of the medical support server apparatus 11.

In this case, the medical support server apparatus 11 is connected in a communicable manner to the client terminals 12, which are installed in the medical facilities, through a WAN (Wide Area Network) (e.g. Internet, public communication network, or the like). The medical support server apparatus 11 accepts (receives) the processing requests from the client terminals 12 of the medical facilities and offers the application services such as delivering the first display screens 15A to the respective client terminals 12.

The data center and the medical support server apparatus 11 may be installed in or managed by one of the medical facilities or a service company independent from the medical facility. In a case where a WAN (e.g. a network or the like) is used, it is preferred to construct a VPN (Virtual Private Network) or to use a communication protocol with a high security level (e.g. HTTPS (Hypertext Transfer Protocol Secure) or the like).

The embodiments of the present invention are not limited to those described above. Various changes and modifications are possible in the embodiments so long as they are within the scope of the present invention. Various embodiments may be combined with the modified embodiments.

What is claimed is:

1. A medical support apparatus comprising:
a screen generator configured to generate a display screen, the display screen having a patient list in which icons are arranged in a matrix in a two-dimensional area with an item arrangement axis and a patient identification information arrangement axis, a plurality of medical care processes performed on patients by medical staffs being arranged as items along the item arrangement axis, patient identification information for identifying the patients being arranged along the patient identification information arrangement axis, the icons representing progress statuses of the medical care processes on a patient-by-patient basis, the icons including a special icon, two or more small icons representing the respective progress statuses of the medical care processes being disposed in the special icon; and
a screen display controller configured to change a display state of the icon in accordance with a change in the progress status, the icons including the small icons.

2. The medical support apparatus according to claim 1, wherein the icon is displayed only for the medical care process scheduled to be performed.

3. The medical support apparatus according to claim 1, wherein the icons include the special icon and a general icon, the general icon representing the progress status of the one medical care process, and the special icon and the general icon are of the same size.

4. The medical support apparatus according to claim 3, wherein text information about the medical care process is displayed in the general icon.

5. The medical support apparatus according to claim 3, wherein the progress status represented by the general icon is at least one of “not started”, “not completed”, and “completed”, and the progress status “not started” corresponds to a state in which the medical care process has not been started, and the progress status “not completed” corresponds to a state in which the medical care process has been started but has not been completed, and the progress status “completed” corresponds to a state in which the medical care process has been completed.

6. The medical support apparatus according to claim 1, wherein the small icons included in the one special icon represent the progress statuses of the medical care processes of the same category.

7. The medical support apparatus according to claim 6, wherein the medical care processes of the same category are medical examinations.

8. The medical support apparatus according to claim 6, wherein the medical examination is at least one of imaging examination, laboratory test, and physiological test.

9. The medical support apparatus according to claim 7, wherein the progress status represented by the small icon is at least one of “not performed”, “not checked”, and “checked”, and the progress status “not performed” corresponds to a state in which the medical examination has not been performed, and the progress status “not checked” corresponds to a state in which the medical examination has been performed but the medical staff has not checked a result of the medical examination or a medical report that is a report on the result of the medical examination, and the progress status “checked” corresponds to a state in which the result of the examination or the medical report has been checked.

10. The medical support apparatus according to claim 9, wherein the display screen displays the number of the medical examinations with the progress status “not checked”.

11. The medical support apparatus according to claim 1, wherein the patient list is operated to display detailed information of the medical care process.

12. The medical support apparatus according to claim 11, wherein the detailed information includes a result of the medical examination and a medical report that is a report on the result of the medical examination.

13. The medical support apparatus according to claim 1, wherein the patient list corresponding to the medical staff is generated, and at least one of the item displayed, the patient identification information, and the progress status in the patient list varies according to the patient and the medical care process of whom and of which the medical staff is in charge.

14. The medical support apparatus according to claim 1, wherein the patient list corresponding to a patient type is generated, and at least one of the item displayed, the patient identification information, and the progress status in the patient list varies according to the patient type.

15. The medical support apparatus according to claim 14, wherein the patient types include a surgery scheduled patient scheduled to have surgery, an outpatient visiting a medical facility, and an inpatient admitted to the medical facility.

16. The medical support apparatus according to claim 1, wherein a change in the progress status is represented by changing at least one of a color of the icon, a line type of the icon, a mark displayed in the icon, and a display position of the small icon in the special icon.

17. The medical support apparatus according to claim 16, wherein the mark is a progress bar.

18. A method for operating a medical support apparatus comprising the steps of:
generating a display screen, the display screen having a patient list in which icons are arranged in a matrix in a two-dimensional area with an item arrangement axis and a patient identification information arrangement axis, a plurality of medical care processes performed on patients by medical staffs being arranged as items along the item arrangement axis, patient identification information for identifying the patients being arranged along the patient identification information arrangement axis, the icons representing progress statuses of the medical care processes on a patient-by-patient basis, the icons including a special icon, two or more small icons representing the respective progress statuses of the medical care processes being disposed in the special icon; and
changing a display state of the icon in accordance with a change in the progress status, the icons including the small icons.

19. A medical support system comprised of a medical support apparatus, a client terminal, and a network that connects the medical support apparatus and the client terminal in a communicable manner, the medical support system comprising:
a screen generator configured to generate a display screen, the display screen having a patient list in which icons are arranged in a matrix in a two-dimensional area with an item arrangement axis and a patient identification information arrangement axis, a plurality of medical care processes performed on patients by medical staffs being arranged as items along the item arrangement axis, patient identification information for identifying the patients being arranged along the patient identification information arrangement axis, the icons representing progress statuses of the medical care processes on a patient-by-patient basis, the icons including a special icon, two or more small icons representing the respective progress statuses of the medical care processes being disposed in the special icon; and
a screen display controller configured to change a display state of the icon in accordance with a change in the progress status, the icons including the small icons.
